(19) United States
(12) Patent Application Publication
(10) Pub. No.: US 2026/0222629 A1
(43) Pub. Date: Jul. 30, 2026

(54) VIDEO CODING APPARATUS AND DECODING APPARATUS

(71) Applicant: SHARP KABUSHIKI KAISHA, Sakai City, Osaka (JP)

(72) Inventors: TAKESHI CHUJOH, Sakai City, Osaka (JP); TOMOHIRO IKAI, Sakai City, Osaka (JP); YUKINOBU YASUGI, Sakai City, Osaka (JP); YASUAKI TOKUMO, Sakai City, Osaka (JP); TOMOKO AONO, Sakai City, Osaka (JP); Keiichiro TAKADA, Sakai City, Osaka (JP); Zheming FAN, Sakai City, Osaka (JP)

(21) Appl. No.: 19/142,406

(22) PCT Filed: Oct. 30, 2023
(86) PCT No.: PCT/JP2023/039041

§ 371 Date: Jun. 23, 2025

(30) Foreign Application Priority Data
Dec. 26, 2022 (JP) 2022-208358
Feb. 17, 2023 (JP) 2023-023430

(51) Int. Cl. H04N 19/86; H04N 19/70

(52) U.S. Cl. CPC H04N 19/86; H04N 19/70

(57) ABSTRACT

In a video coding and decoding method, although image quality is deteriorated due to coding distortion in a case that a transmission rate is low, the image quality can be improved due to post-filtering processing using a neural network; however, there is a problem that supplemental enhancement information cannot be efficiently generated depending on a prediction structure. A video decoding apparatus according to an aspect of the present invention decodes, with an image decoding apparatus configured to decode coded data to generate a decoded image, a post-filtering processing apparatus configured to perform post-filtering processing on the decoded image, and a supplemental enhancement information decoding apparatus configured to decode supplemental enhancement information indicating whether to perform post-filtering processing on a per picture basis with the post-filtering processing apparatus, information indicating whether to continue post-filtering processing in a decoding order or in a display output order in a case of determining whether to continue post-filtering processing on a per picture basis in the supplemental enhancement information.

### TECHNICAL FIELD

Embodiments of the present invention relate to a video coding apparatus and a decoding apparatus.

### BACKGROUND ART

A video coding apparatus which generates coded data by coding a video, and a video decoding apparatus which generates decoded images by decoding coded data are used for efficient transmission or recording of videos.

Specific video coding schemes include, for example, H.264/AVC and an H.265/High-Efficiency Video Coding (HEVC) scheme, and the like.

In such a video coding scheme, images (pictures) constituting a video are managed in a hierarchical structure including slices obtained by splitting an image, Coding Tree Units (CTUs) obtained by splitting a slice, Coding Units (CUs) obtained by splitting a coding tree unit, and Transform Units (TUs) obtained by splitting a coding unit, and are coded/decoded for each CU.

In such a video coding scheme, usually, a prediction image is generated based on a locally decoded image that is obtained by coding/decoding an input image, and a prediction error (which may be referred to also as a “difference image” or a “residual image”) obtained by subtracting the prediction image from the input image (source image) is coded. Generation methods of prediction images include inter picture prediction (inter prediction) and intra picture prediction (intra prediction).

In addition, NPL 1 introduces an example of recent techniques for video coding and decoding.

NPL 1 discloses a video coding and decoding scheme with very high coding efficiency.

A Supplemental Enhancement Information (SEI) message for transmitting image properties, display methods, timings, and the like simultaneously with coded data is defined in NPL 2 and NPL 3. In addition, SEI for transmitting the topology and parameters of a neural network filter used as a post-filter in a randomly accessible unit is disclosed. The SEI for transmitting whether post-filtering processing is performed on a per picture basis is disclosed.

As a method for improvement, NPL 3 describes a method of separately defining bit lengths for luminance and chrominance in a case that input tensors of a neural network are integer values.

Further, NPL 3 also discloses SEI for transmitting hint information for post-filtering processing.

### CITATION LIST

### Non Patent Literature

NPL 1: ITU-T Recommendation H. 266
NPL 2: Text of ISO/IEC 23002-7:202x (2nd Ed.) DAM1 Additional SEI messages, November 2022.
NPL 3: Improvements under consideration for neural network post filter SEI messages, JVET-AC2032, 2023 Feb. 1.

### SUMMARY OF INVENTION

### Technical Problem

However, although the method disclosed in NPL 1 is about a video coding and decoding scheme having very high coding efficiency, the method has a problem of a deteriorating image quality due to coding distortion in a case that the transmission rate is low.

In addition, in the method disclosed in NPL 2, it is possible to improve the image quality in a case that the transmission rate is low by using post-filtering processing using a neural network, but in a case that a video is efficiently compressed, coded, transmitted, and decoded, there is a case that the display order of pictures and the coding and decoding order are different depending on a prediction structure, and in such a case, there is a problem that supplemental enhancement information cannot be efficiently generated.

In the method disclosed in NPL 3, in a case that a cross correlation matrix is defined as post-filter hint information, there is a problem of the value of each element of the matrix becoming too small, resulting in reduced accuracy.

In addition, in the method disclosed in NPL 3, in a case that up-sampling processing is performed on chrominance, in a case that the input is in the 4:2:2 format, the chrominance up-sampling is always in the 4:4:4 format, and thus there is a problem of flag information being redundant.

### Solution to Problem

Included are an image decoding apparatus configured to decode coded data to generate a decoded image, a post-filtering processing apparatus configured to perform post-filtering processing on the decoded image, and a supplemental enhancement information decoding apparatus configured to decode supplemental enhancement information used by the post-filtering processing apparatus, wherein the supplemental enhancement information decoding apparatus decodes cross correlation matrix information of the decoded image with a certain bit accuracy independent of a pixel bit length of the decoded image and an original image.

In addition, the supplemental enhancement information decoding apparatus does not decode flag information for an output format at a time when up-sampling processing is performed on a chroma pixel of a decoded image in a 4:2:2 format.

A video coding apparatus according to an aspect of the present invention includes an image coding apparatus configured to code an input image, a supplemental enhancement information generating apparatus configured to generate supplemental enhancement information for post-filtering processing, and a supplemental enhancement information coding apparatus configured to code the supplemental enhancement information, wherein the supplemental enhancement information generating apparatus generates cross correlation matrix information of a local decoded image with a certain bit accuracy independent of a pixel bit length of a decoded image and an original image, and the supplemental enhancement information coding apparatus configured to code the cross correlation matrix information is included.

In addition, the supplemental enhancement information generating apparatus generates supplemental enhancement information for up-sampling processing of a chroma pixel of a decoded image in a 4:2:2 format and the supplemental enhancement information coding apparatus does not decode flag information for an output format.

### Advantageous Effects of Invention

With the above configuration, it is possible to solve the problem that the supplemental enhancement information cannot be efficiently generated depending on a prediction structure in a case that the display order of pictures is different from the coding and decoding order. In addition, by adopting the above-described configuration in the method disclosed in NPL, in a case that a cross correlation matrix is defined as post-filter hint information, the problem of the value of each element of the matrix becoming too small, resulting in reduced accuracy, can be solved. In addition, in the method disclosed in NPL, in a case that up-sampling processing is performed on chrominance, in a case that the input is in the 4:2:2 format, the up-sampling of chrominance is always in the 4:4:4 format, and thus the problem of flag information being redundant can be solved.

### BRIEF DESCRIPTION OF DRAWINGS

FIG. 1 is a schematic diagram illustrating a configuration of a video transmission system according to the present embodiment.

FIG. 2 is a diagram illustrating a hierarchical structure of coded data.

FIG. 3 is a diagram illustrating a hierarchical structure of coded data in units of sequence.

FIG. 4 is a schematic diagram illustrating a configuration of an image decoding apparatus.

FIG. 5 is a flowchart for illustrating general operation of the image decoding apparatus.

FIG. 6 is a block diagram illustrating a configuration of an image coding apparatus.

FIG. 7 is a diagram illustrating an overview of syntax of neural network post-filter characteristics (NNPFC) SEI.

FIG. 8 is a diagram illustrating syntax of neural network post-filter activation (NNPFA) SEI.

FIG. 9 is a diagram illustrating syntax of post-filter hint SEI.

FIG. 10 shows an example of a prediction structure in which the display output order and the coding and decoding order are different.

FIG. 11 is a diagram illustrating syntax of neural network post-filter activation (NNPFA) SEI defining supplemental enhancement information of the present embodiment.

FIG. 12 is a diagram illustrating syntax of an SEI payload being a container of an SEI message.

FIG. 13 is a diagram showing a flowchart of processing of a post-filtering processing apparatus 61.

FIG. 14 is a diagram illustrating a coding apparatus and a decoding apparatus for NNC.

FIG. 15 is a diagram showing a formula for obtaining a cross correlation matrix according to NPL.

FIG. 16 is a diagram showing a formula for obtaining a cross correlation matrix according to the present embodiment.

FIG. 17 is a diagram showing another formula for obtaining a cross correlation matrix according to the present embodiment.

### DESCRIPTION OF EMBODIMENTS

### First Embodiment

Embodiments of the present invention will be described below with reference to the drawings.

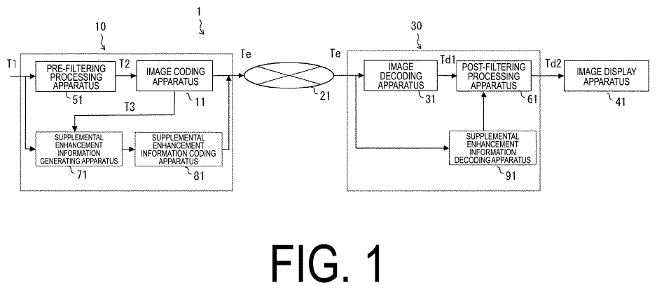

FIG. 1 is a schematic diagram illustrating a configuration of a video transmission system according to the present embodiment.

The video transmission system 1 is a system in which coded data obtained by coding an image is transmitted, the transmitted coded data is decoded, and thus the coded data is displayed. The video transmission system 1 includes a video coding apparatus 10, a network 21, a video decoding apparatus 30, and an image display apparatus 41.

The video coding apparatus 10 includes an image coding apparatus (image coder) 11, a supplemental enhancement information generating apparatus (supplemental enhancement information generating unit) 71, a supplemental enhancement information coding apparatus (supplemental enhancement information coder) 81, and a pre-filtering processing apparatus (pre-filtering processing unit) 1001.

The video coding apparatus 10 creates a pre-filtering processing image T2 from an input video T1 in the pre-filtering processing apparatus 51, performs compression and coding of the image in the image coding apparatus 11 and analyzes the input video T1 and a local decoded image T3 of the image coding apparatus 11, generates supplemental enhancement information for input to a post-filtering processing apparatus 61 in the supplemental enhancement information generating apparatus 71, performs coding in the supplemental enhancement information coding apparatus 81, generates coded data Te, and transmits the coded data Te to the network 21.

The video decoding apparatus 30 includes an image decoding apparatus (image decoder) 31, a supplemental enhancement information decoding apparatus (supplemental enhancement information decoder) 91, and a post-filtering processing apparatus (post-filtering processing unit) 61.

The video decoding apparatus 30 decodes the coded data Te received from the network 21 in the image decoding apparatus 31 and the supplemental enhancement information decoding apparatus 91, performs post-filtering processing on a decoded image Td1 in the post-filtering processing apparatus 61 using supplemental enhancement information, and outputs a post-filter decoded image Td2 to the image display apparatus 41.

Note that the post-filtering processing apparatus 61 may directly output the decoded image Td1 without performing the post-filtering processing using the supplemental enhancement information.

The image display apparatus 41 displays all or a part of the post-filter decoded image Td2 output from the post-filtering processing apparatus 1002. For example, the image display apparatus 41 includes a display device such as a liquid crystal display and an organic Electro-luminescence (EL) display. Examples of display types include stationary, mobile, and HMD. In addition, in a case that the image decoding apparatus 31 has a high processing capability, an image having high image quality is displayed, and in a case that the apparatus has a lower processing capability, an image which does not require a high processing capability and display capability is displayed.

The network 21 transmits the coded supplemental enhancement information and the coded data Te to the image decoding apparatus 31. A part or all of the coded supplemental enhancement information may be included in the coded data Te as supplemental enhancement information SEI. The network 21 is the Internet, a Wide Area Network (WAN), a Local Area Network (LAN), or a combination thereof. The network 21 is not limited to a bidirectional communication network and may be a unidirectional communication network that transmits broadcast waves for terrestrial digital broadcasting, satellite broadcasting, or the like. The network 21 may be substituted with a storage medium in which the coded data Te is recorded, such as a Digital Versatile Disc (DVD) (trade name) or a Blue-ray Disc (BD) (trade name).

As an example of a specific embodiment, in the pre-filtering processing, an input image may be reduced, and regarding the supplemental enhancement information, in the post-filtering processing, the supplemental enhancement information for neural network processing for enlarging a decoded image through super-resolution processing based on a neural network may be coded and decoded.

As another example of a specific embodiment, in the pre-filtering processing, processing may not be particularly performed, and regarding the supplemental enhancement information, in the post-filtering processing, the supplemental enhancement information for neural network processing for restoring a decoded image into an input video through image restoration processing based on a neural network may be coded and decoded.

In such a configuration, a framework for enabling efficient coding and decoding of the supplemental enhancement information is provided.

### Operators

Operators used in the present specification will be described below.

“>>” is a right bit shift, “<<” is a left bit shift, “&” is a bitwise AND, “|” is a bitwise OR, “|=” is an OR assignment operator, and “|” indicates a logical sum.

x?y: z is a ternary operator that takes y in a case that x is true (not 0) and takes z in a case that x is false (0).

Clip3 (a, b, c) is a function to clip c in a value from a to b, and a function to return a in a case that c is smaller than a (c<a), return b in a case that c is greater than b (c>b), and return c in the other cases (provided that a is smaller than or equal to b (a<=b)).

abs (a) is a function that returns the absolute value of a.

Int(a) is a function that returns the integer value of a.

Floor (a) is a function that returns the maximum integer equal to or less than a.

ceil(a) is a function that returns the minimum integer equal to or greater than a.

a/d represents division of a by d (round down decimal places).

a÷d and a divided by d represent division of a by d (not rounded down).

### Structure of Coded Data Te

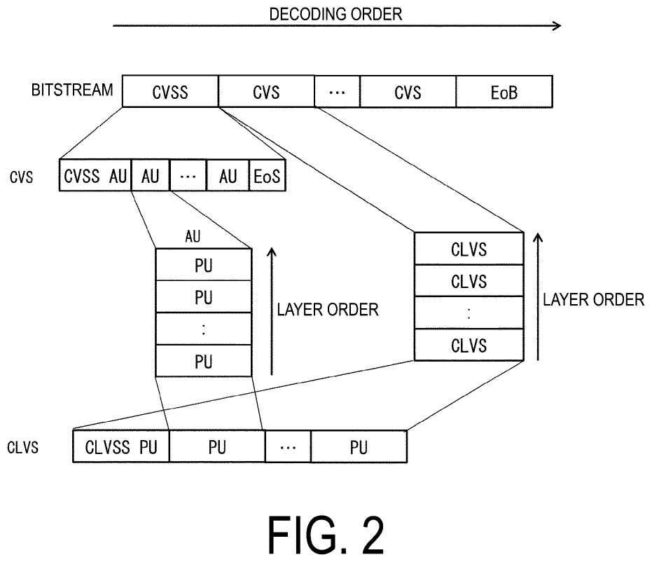

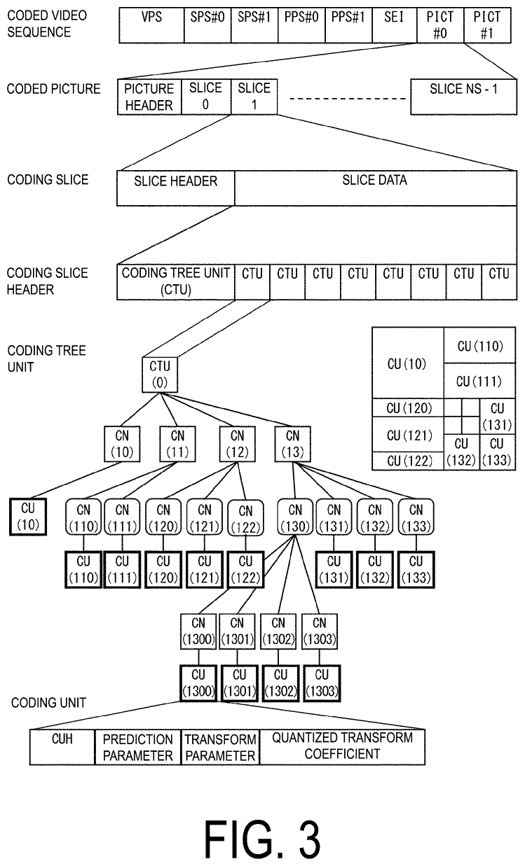

Prior to the detailed description of the image coding apparatus 11 and the image decoding apparatus 31 according to the present embodiment, a data structure of the coded data Te generated by the image coding apparatus 11 and decoded by the image decoding apparatus 31 will be described with reference to FIGS. 2 and 3.

The coded data Te is a bitstream including multiple Coded Video Sequences (CVSs) and an End of Bitstream (EoB) NAL unit illustrated in FIG. 2. The CVS includes multiple Access Units (AUs) and an End of Sequence (EoS) NAL unit. The AU at the start of the CVS is referred to as a Coded Video Sequence Start (CVSS) AU. A unit obtained by splitting the CVS for each layer is referred to as a Coded Layer Video Sequence (CLVS). The AU includes Picture Units (PUs) of one or multiple layers at the same output time. In a case that a Multilayer coding scheme is not adopted, the AU includes one PU. The PU is a unit of coded data of one decoded picture including multiple NAL units. The CLVS includes PUs of the same layer, and the PU at the start of the CLVS is referred to as a Coded Layer Video Sequence Start (CLVSS) PU. The CLVSS PU is limited to the PU including randomly accessible Intra Random Access Pictures (IRAP) or Gradual Decoder Refresh Picture (GDR). The NAL unit includes a NAL unit header and Raw Byte Sequence Payload (RBSP) data. The NAL unit header includes, subsequently to 0 data of 2 bits, nuh_layer_id of 6 bits indicating a layer value, nuh_unit_type of 5 bits indicating a NAL unit type, and nuh_temporal_id_plus1 of 3 bits of a value obtained by adding 1 to a Temporal ID value.

FIG. 3 is a diagram illustrating a hierarchical structure of data in the coded data Te in units of PU. The coded data Te includes a sequence and multiple pictures constituting the sequence illustratively. FIG. 3 is a diagram illustrating a coded video sequence defining a sequence SEQ, a coded picture prescribing a picture PICT, a coding slice prescribing a slice S, a coding slice data prescribing slice data, a coding tree unit included in the coding slice data, and a coding unit included in the coding tree unit.

In the coded video sequence, a set of data referred to by the image decoding apparatus 31 to decode the sequence SEQ to be processed is defined. As illustrated in FIG. 3, the sequence SEQ includes a Video Parameter Set VPS, a Sequence Parameter Set SPS, a Picture Parameter Set PPS, an Adaptation Parameter Set (APS), a picture PICT, and Supplemental Enhancement Information SEI.

In the video parameter set VPS, with respect to a video including multiple layers, a set of coding parameters common to multiple videos and a set of coding parameters associated with the multiple layers and an individual layer included in the video are defined.

In the sequence parameter set SPS, a set of coding parameters referred to by the image decoding apparatus 31 to decode a target sequence is defined. For example, a width and a height of a picture are defined. Note that multiple SPSs may exist. In that case, any of the multiple SPSs is selected from the PPS.
pic_width_max_in_luma_samples: A syntax element indicating, in units of luma blocks, the width of one of the images in a single sequence, the image having the largest width. In addition, the syntax element has a value required to not be 0 and to be an integer multiple of Max(8, MinCbSizeY). Here, MinCbSizeY is a value determined by the minimum size of the luma blocks.
pic_height_max_in_luma_samples: A syntax element indicating, in units of luma blocks, the height of one of the images in a single sequence, the image having the largest height. In addition, the syntax element has a value required to not be 0 and to be an integer multiple of Max(8, MinCbSizeY).

In the picture parameter set PPS, a set of coding parameters referred to by the image decoding apparatus 31 to decode each picture in a target sequence is defined. Note that multiple PPSs may exist. In that case, any of the multiple PPSs is selected from each picture in a target sequence.

Here, the picture parameter set PPS includes the following syntax elements.
pps_pic_width_in_luma_samples: A syntax element indicating the width of a target picture. The syntax element is required to have a value that is not 0 and that is an integer multiple of Max(8, MinCbSizeY) and that is equal to or less than sps_pic_width_max_in_luma_samples. InpPicWidthInLumaSamples to be described later is set equal to pps_pic_width_in_luma_samples.
pps_pic_height_in_luma_samples: A syntax element indicating the height of the target picture. The syntax element is required to have a value that is not 0 and that is an integer multiple of Max(8, MinCbSizeY) and that is equal to or less than sps_pic_height_max_in_luma_samples. InpPicHeightInLumaSamples to be described later is set equal to pps_pic_height_in_luma_samples.
pps_conformance_window_flag: A flag indicating whether a conformance (cropping) window offset parameter is subsequently signaled, the flag indicating a location where a conformance window is displayed. In a case that the flag is 1, the parameter is signaled, and in a case that the flag is 0, then no conformance window offset parameter is present.
sps_chroma_format_id is a parameter indicating a chroma format. ChromaFormatIdc to be described later is set equal to sps_chroma_format_id.

Here, the variable ChromaFormatIdc of the chroma format is the value of sps_chroma_format_id, and the variables SubWidthC and SubHightC are values determined by the ChromaFormatIdc. The values of both SubWidthC and SubHightC are 1 in a case of a monochrome format, the values of both SubWidthC and SubHightC are 2 in a case of the 4:2:0 format, the value of SubWidthC is 2 and the value of SubHightC is 1 in a case of the 4:2:2 format, and the values of both SubWidthC and SubHightC are 1 in a case of the 4:4:4 format,
pps_init_qp_minus26 is information for deriving a quantization parameter SliceQpY of a slice referred to in the PPS.

### Coded Picture

In a coded picture, a set of data referred to by the image decoding apparatus 31 to decode a picture PICT to be processed is defined. As illustrated in FIG. 3, the picture PICT includes a picture header PH and slices 0 to NS−1 (NS is the total number of slices included in the picture PICT).

### Coding Slice

In a coding slice, a set of data referred to by the image decoding apparatus 31 to decode a slice S to be processed is defined. As illustrated in FIG. 3, the slice includes a slice header and slice data.

The slice header includes a coding parameter group referenced by the image decoding apparatus 31 to determine a decoding method for a target slice. Slice type indication information (slice_type) indicating a slice type is one example of a coding parameter included in the slice header.

Examples of slice types that can be indicated by the slice type indication information include (1) I slice for which only intra prediction is used in coding, (2) P slice for which uni-prediction (L0 prediction) or intra prediction is used in coding, and (3) B slice for which uni-prediction (L0 prediction or L1 prediction), bi-prediction, or intra prediction is used in coding, and the like. Note that the inter prediction is not limited to uni-prediction and bi-prediction, and a prediction image may be generated by using a larger number of reference pictures. Hereinafter, in a case of a slice being referred to as a P or B slice, it indicates a slice including a block in which inter prediction can be used.

Note that the slice header may include a reference to the picture parameter set PPS (pic_parameter_set_id).

### Coding Slice Data

In coding slice data, a set of data referred to by the image decoding apparatus 31 to decode slice data to be processed is defined. The slice data includes CTUs as illustrated in the coding slice header in FIG. 3. A CTU is a block in a fixed size (for example, 64×64) constituting a slice, and may also be called a Largest Coding Unit (LCU).

### Coding Tree Unit

In FIG. 3, a set of data is defined that is referenced by the image decoding apparatus 31 to decode the CTU to be processed. The CTU is split into coding units CUs, each of which is a basic unit of coding processing, by a recursive Quad Tree (QT) split, Binary Tree (BT) split, or Ternary Tree (TT) split. A node of a tree structure obtained by recursive quad tree split is referred to as a Coding Node. An intermediate node of a quad tree, a binary tree, and a ternary tree is a coding node, and a CTU itself is also defined as the highest coding node.

### Coding Unit

In FIG. 3, a set of data referenced by the image decoding apparatus 31 to decode the coding unit to be processed is defined. Specifically, a CU includes a CU header CUH, a prediction parameter, a transform parameter, a quantized transform coefficient, and the like. In the CU header, a prediction mode and the like are defined.

The prediction processing may be performed for each CU or performed for each sub-CU, the sub-CU being obtained by further splitting the CU.

There are two types of predictions (prediction modes), which are intra prediction and inter prediction. Intra prediction refers to prediction in the same picture, and inter prediction refers to prediction processing performed between different pictures (for example, between pictures of different display times, and between pictures of different layer images).

Although transform and quantization processing is performed for each CU, entropy coding of a quantized transform coefficient may be performed for each subblock such as 4×4.

Note that, in a case that the present specification mentions “a flag indicating whether XX is applied”, the flag indicating a value other than 0 (for example, 1) means a case where XX is applied, and the flag indicating 0 means a case where XX is not applied, and 1 is treated as true and 0 is treated as false in a logical negation, a logical product, and the like (hereinafter, the same applies). However, other values can be used for true values and false values in real apparatuses and methods.

### Configuration of Image Decoding Apparatus

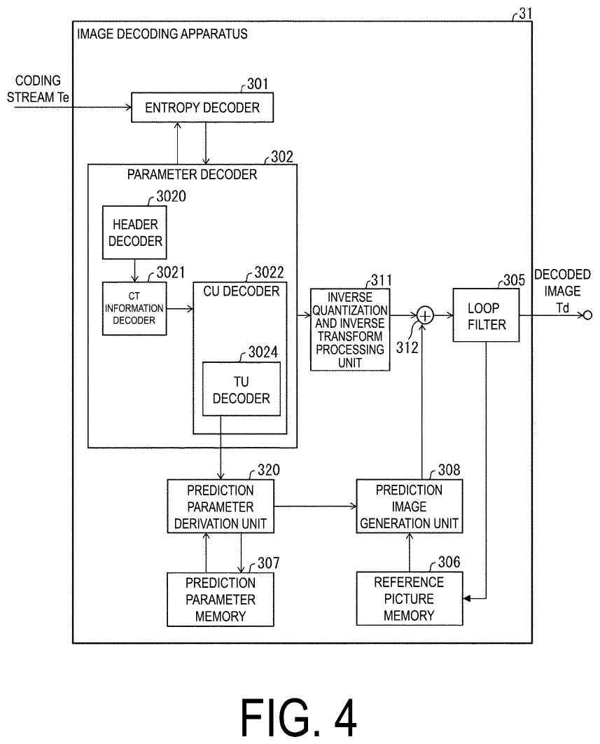

The configuration of the image decoding apparatus 31 (FIG. 4) according to the present embodiment will be described.

The image decoding apparatus 31 includes an entropy decoder 301, a parameter decoder (a prediction image decoding apparatus) 302, a loop filter 305, a reference picture memory 306, a prediction parameter memory 307, a prediction image generation unit (prediction image generation apparatus) 308, an inverse quantization and inverse transform processing unit 311, an addition unit 312, and a prediction parameter derivation unit 320. Note that the image decoding apparatus 31 may not include the loop filter 305 in accordance with the image coding apparatus 11 described later.

The parameter decoder 302 further includes a header decoder 3020, a CT information decoder 3021, and a CU decoder 3022 (prediction mode decoder), and the CU decoder 3022 further includes a TU decoder 3024. These may be collectively referred to as a decoding module. The header decoder 3020 decodes, from coded data, parameter set information such as a VPS, an SPS, a PPS, and an APS, and a slice header (slice information). The CT information decoder 3021 decodes a CT from coded data. The CU decoder 3022 decodes a CU from coded data. The TU decoder 3024 decodes QP update information (quantization correction value) and quantization prediction error (residual_coding) from coded data.

The prediction image generation unit 308 includes an inter prediction image generation unit 309 and an intra prediction image generation unit 310.

The entropy decoder 301 performs entropy decoding on the coded data Te input from an external source and decodes individual codes (syntax elements).

The entropy decoder 301 outputs the decoded codes to the parameter decoder 302. Which code is to be decoded is controlled based on an indication of the parameter decoder 302.

### Basic Flow

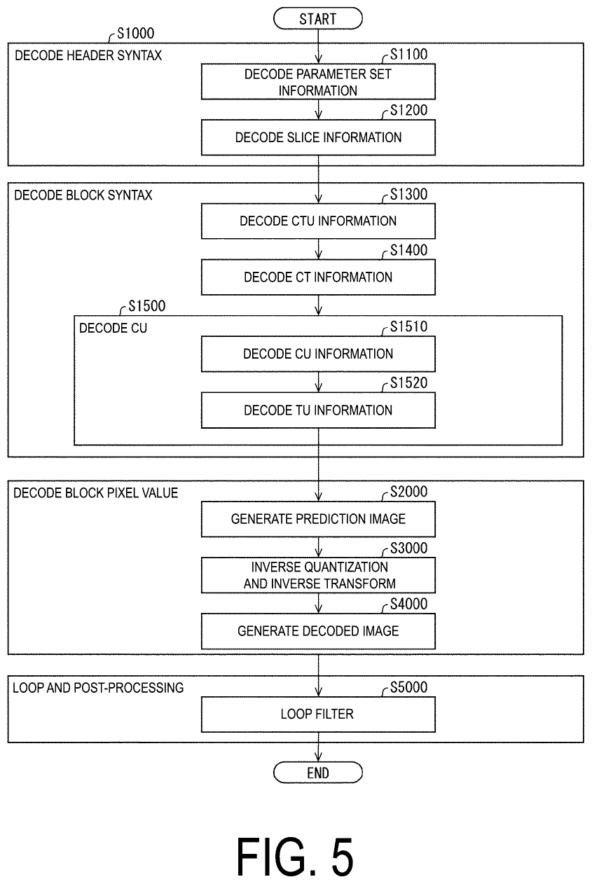

FIG. 5 is a flowchart illustrating general operation of the image decoding apparatus 31.

(S1100: Decoding of parameter set information) The header decoder 3020 decodes parameter set information such as a VPS, an SPS, and a PPS from coded data.

(S1200: Decoding of slice information) The header decoder 3020 decodes a slice header (slice information) from the coded data.

Afterwards, the image decoding apparatus 31 repeats the processing from S1300 to S5000 for each CTU included in the target picture, and thereby derives a decoded image of each CTU.

(S1300: Decoding of CTU information) The CT information decoder 3021 decodes the CTU from the coded data.

(S1400: Decoding of CT information) The CT information decoder 3021 decodes the CT from the coded data.

(S1500: Decoding of CU) The CU decoder 3022 decodes the CU from the coded data by performing S1510 and S1520.

(S1510: Decoding of CU information) The CU decoder 3022 decodes CU information, prediction information, and the like from the coded data.

(S1520: Decoding of TU information) The TU decoder 3024 decodes QP update information, a quantization prediction error, and the like from the coded data. Note that QP update information is a difference value from a quantization parameter prediction value qPpred, which is a prediction value of a quantization parameter QP.

(S2000: Generation of prediction image) The prediction image generation unit 308 generates a prediction image, based on the prediction information, for each block included in the target CU.

(S3000: Inverse quantization and inverse transform) The inverse quantization and inverse transform processing unit 311 performs inverse quantization and inverse transform processing on each TU included in the target CU.

(S4000: Generation of decoded image) The addition unit 312 generates a decoded image of the target CU by adding the prediction image supplied by the prediction image generation unit 308 and the prediction error supplied by the inverse quantization and inverse transform processing unit 311.

(S5000: Loop filter) The loop filter 305 generates a decoded image by applying a loop filter such as a deblocking filter, an SAO, and an ALF to the decoded image.

Although the method disclosed in NPL 1 is about a video coding and decoding scheme having very high coding efficiency, the method has a problem of a deteriorating image quality due to coding distortion in a case that the transmission rate is low.

In addition, in the method disclosed in NPL 2, it is possible to improve the image quality in a case that the transmission rate is low due to post-filtering processing using a neural network, but in a case that a video is efficiently compressed, coded, transmitted, and decoded, there is a case that the display order of pictures and the coding and decoding order are different depending on a prediction structure, and in such a case, there is a problem that supplemental enhancement information cannot be efficiently generated.

In the present embodiment, even in a case that a transmission rate is low, the image quality can be improved and efficient coding and decoding of the supplemental enhancement information is possible regardless of a prediction structure.

### Neural Network Post-Filter Characteristics (NNPFC) SEI

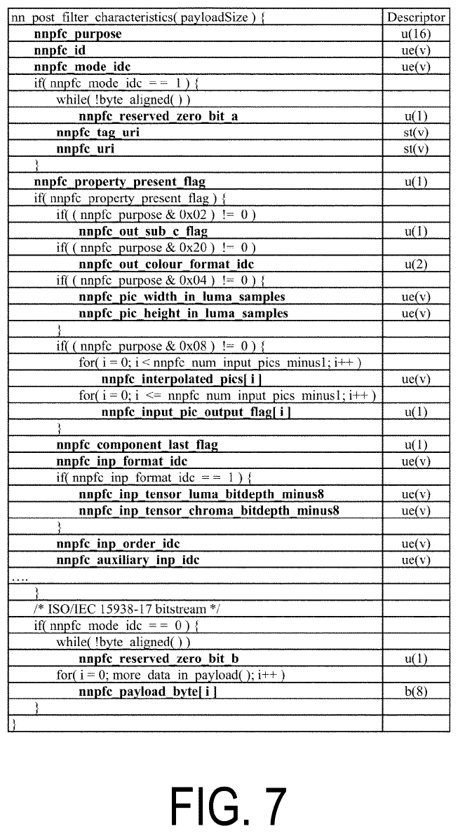

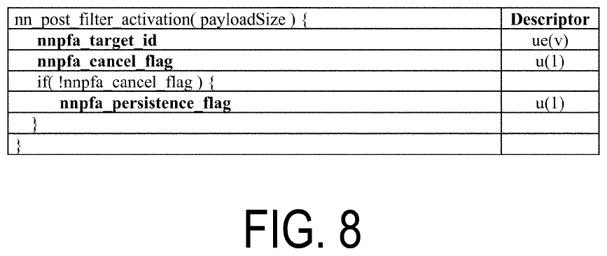

FIG. 7 illustrates an outline of syntax of a neural network post-filter characteristics (NNPFC) SEI message of NPL 2. The supplemental enhancement information decoding apparatus 91 decodes syntax elements (for example, nnpfc_auxiliary_inp_idc, nnpfc_inp_order_idc, nnpfc_inp_format_idc, and the like) illustrated in FIG. 7. The NNPFC SEI message indicates the neural network to be applied as the post-filtering processing. Application of specific post-filtering processing for a specific picture is indicated by a neural network post-filter activation SEI message (FIG. 8).

To apply the SEI message, the following variables need to be defined.
A width InpPicWidthInLumaSamples and a height InpPicHeightInLumaSamples of a picture decoded by the image decoding apparatus 31 in a luma pixel unit.
Picture luma pixel array CroppedYPic[idx] and chroma pixel array CroppedCbPic[idx] and CroppedCrPic[idx] with idx ranging from 0 to numInputPics−1 used as input for post-filtering processing
pixel bit depth BitDepthY of the luma pixel array
pixel bit length BitDepthC of the chroma pixel array
variables SubWidthC and SubHeightC indicating a chroma format indicated by a chroma format ChromaFormatIdc of the picture. In a case of 4:2:0, the variables SubWidthC and SubHeightC are both 2, in a case of 4:2:2, the variable SubWidthC is 2 and the variable SubHeightC is 1, and in a case of 4:4:4, the variables SubWidthC and SubHeightC are both 1.

nnpfc_auxiliary_inp_idc indicates that supplemental input data is present in the input tensor of the neural network post-filter. In a case that the value is equal to 1, the strength control value StrengthControlVal (strength control information) being a real number in a range from 0 to 1 is input as the supplemental input data. Note that the real number may be a decimal number or a floating-point number. The strength control value may be, as with a quantization parameter, a value obtained in a process of generating a decoded image.

nnpfc_purpose indicates the purpose of the processing. In a case that the value of nnpfc_purpose is 0, it may be used as determined by the application.

The case that nnnpfc_purpose is greater than 0 and the value of (nnpfc_purpose & 0×01) is 0 indicates that general visual quality improvement is not the goal. The case that the value of (nnpfc_purpose & 0×01) is not 0 indicates that the purpose is to improve general visual qualities.

The case that nnnpfc_purpose is greater than 0 and the value of (nnpfc_purpose & 0×02) is 0 indicates that there is no processing of chrominance up-sampling (from the 4:2:0 format to the 4:2:2 or 4:4:4 format, or from the 4:2:2 format to the 4:4:4 format). The case that the value of (nnpfc_purpose & 0×02) is not 0 indicates that there is processing of chroma up-sampling.

The case that nnnpfc_purpose is greater than 0 and the value of (nnpfc_purpose & 0×04) is 0 indicates that there is no processing of resolution up-sampling (increase in height or depth of pictures). The case that the value of (nnpfc_purpose & 0×04) is not 0 indicates that there is processing of resolution up-sampling.

The case that nnnpfc_purpose is greater than 0 and the value of (nnpfc_purpose & 0×08) is 0 indicates that there is no processing of picture rate up-sampling. The case that the value of (nnpfc_purpose & 0×08) is not 0 indicates that there is processing of picture rate up-sampling.

The case that nnnpfc_purpose is greater than 0 and the value of (nnpfc_purpose & 0×10) is 0 indicates that there is no processing of expanding the pixel bit length (increasing the luma pixel bit length or the chroma pixel bit length). The case that the value of (nnpfc_purpose & 0×10) is not 0 indicates that there is processing of expanding the pixel bit length.

The case that nnnpfc_purpose is greater than 0 and the value of (nnpfc_purpose & 0×20) is 0 indicates that there is no processing of colorization (from the 4:0:0 format to the 4:2:0, 4:2:2, or 4:4:4 format). The case that the value of (nnpfc_purpose & 0×20) is not 0 indicates that the processing of colorization is performed.

Note that, in a case that ChromaFormatIdc is 3, the value of (nnpfc_purpose & 0×02) should be 0. In addition, in a case that ChromaFormatIdc or the value of (nnpfc_purpose & 0×02) is not 0, (nnpfc_purpose & 0×20) should be 0.

nnpfc_id indicates an identification number that can be used for identifying the post-filtering processing.

In a case that the NNPFC SEI message is a first NNPFC SEI message in decoding order having a specific nnpfc_id value in the current CLVS, the following is applied.
The SEI message indicates that it is basic post-filtering processing.
The SEI message relates to the current decoded picture and all of subsequent decoded pictures in the current layer until the end of the current CLVS. In a case that the NNPFC SEI message is the current CLVS and a repetition of a previous NNPFC SEI message in decoding order, for subsequent semantics, the SEI message is applied supposedly as the only NNPFC SEI message having the same contents in the current CLVS.

In a case that the NNPFC SEI message is not the first NNPFC SEI message in decoding order having the specific nnpfc_id value in the current CLVS, the following is applied.
The SEI message indicates that it is an update related to a previous basic post-filter in decoding order using the same nnpfc_id value.
The SEI message relates to the current decoded picture and all of subsequent decoded pictures in the current layer until the end of the current CLVS or until the next NNPFC SEI message having the specific nnpfc_id value in the current layer.

In a case that nnpfc_mode_idc is 0, it indicates whether the SEI message includes an ISO/IEC 15938-17 bitstream indicating the post-filtering processing, or that the SEI message is an update related to a basic post-processing filter having the same nnpfc_id value.

In a case that nnpfc_mode_idc is 1, it indicates that the post-filtering processing associated with the nnpfc_id value is the neural network identified with a URI indicated by nnpfc_uri.

nnpfc_reserved_zero_bit_a indicates 0.

nnpfc_tag_uri includes a tag URI having syntax and semantics indicated by IETF RFC 4151. It is used for a format and related information related to the neural network used as the basic post-filtering processing or update related to the post-filtering processing in which the same nnpfc_id value is indicated. Note that nnpfc_tag_uri enables unique identification of a format of neural network data indicated by nnpfc_uri, without the need of a registration entity. In a case that nnpfc_tag_uri is “tag:iso.org,2023:15938-17”, it indicates that data of the neural network identified by nnpfc_uri conforms to ISO/IEC 15938-17 and is coded with Neural Network Coding (NNC).

nnpfc_uri includes URI having syntax and semantics indicated by IETF Internet Standard 66, and is used as a neural network used as post-filtering processing or an update related to the post-filtering processing having the same nnpfc_id value.

In a case that an nnpfc_property_present_flag is 1, it indicates that syntax elements relating to the purpose of filtering, an input format, an output format, and complexity are present. In a case that an nnpfc_property_present_flag is 0, it indicates that syntax elements relating to the purpose of filtering, an input format, an output format, and complexity are not present. In a case that the SEI message is the first NNPFCSEI message having a specific nnpfc_id value within the current CLVS in decoding order, nnpfc_property_present_flag should be 1. In a case that the SEI message is not the first NNPFC SEI message in decoding order, or the specific nnpfc_id value is present in the current CLVS, the value of nnpfc_property_present_flag should be 0.

nnpfc_inp_format_idc indicates the method of converting a pixel value to be input to the neural network of the post-filtering processing. In a case that nnpfc_inp_format_idc is 0, it indicates that the input value is a real number, and in a case that nnpfc_inp_format_idc is 1, it indicates that the input value is an unsigned integer.

In a case that the value of nnpfc_inp_sample_idc is 0, functions InpY and InpC are derived as follows.

$$InpY ( x ) = x \div ( ( 1 ≪ BitDepthY ) - 1 )$$

$$InpC ( x ) = x \div ( ( 1 ≪ BitDepthC ) - 1 )$$

In a case that the value of nnpfc_inp_sample_idc is 1, the functions InpY and InpC are derived as follows.

```
shift=BitDepthY-InpTensorBitDepth
    if(inpTensorBitDepth>=BitDepthY)
        InpY(x)=x<<(inpTensorBitDepth−BitDepthY)
    else
        InpY(x)=Clip3(0, (1<<inpTensorBitDepth)−1, (x+(1<<(shift−1)))>>
shift)
        shift=BitDepthC−inpTensorBitDepth
        if(impTensorBitDepth>=BitDepthC)
            InpC(x)=x<<(inpTensorBitDepth−BitDepthC)
        else
    InpC(x)=Clip3(0, (1<<)npTensorBitDepth)−1, (x+(1<<(shift−1)))>>shift)
```

In a case that nnpfc_inp_format_idc is 1, the syntax element nnpfc_inp_tensor_bitdepth_minus8 is coded and decoded. The value obtained by adding 8 to nnpfc_inp_tensor_bitdepth_minus8 is bit length inpTensorBitDepth of a case that a pixel value to be input to the neural network of the input post-filtering processing is an unsigned integer, and is derived using the following formula.

inpTensorBitDepth=nnpfc_inp_tensor_bitdepth_minus8+8

The problem of NPL 2 is that, in a case that nnpfc_inp_format_idc is 1 and there is a deblocking filtering strength control value StrengthControlVal that is a real number value between 0 and 1, a method of converting the value of StrengthControlVal into an unsigned integer is not defined.

Therefore, the variable StrengthControlVal is re-defined as follows.

$$StrengthControlVal = floor ( StrengthControlVal * ( ( 1 ≪ inpTensorBitDepth ) - 1 ) )$$

By performing such derivation, even in a case that nnpfc_inp_format_idc is 1, the post-filtering processing can be realized using the neural network with the deblocking filtering strength control value being an unsigned integer value.

In addition, as another solution, by obtaining a strength value StrengthControlValInDecoder obtained from the image decoding apparatus 31, branching may be performed as follows.

```
    if (nnpfc_inp_format_idc == 0)
        StrengthControlVal= StrengthControlValInDecoder
    else if (nnpfc_inp_format_idc == 1)
        StrengthControlVal
                =floor (StrengthControlValInDecoder*((1 <<
inpTensorBitDepth)−1)
```

Note that, for StrengthControlVal (StrengthControlValInDecoder), the image decoding apparatus 31 may normalize the value of the quantization parameter obtained from coded data and configure it to a decimal number between 0 and 1.

$$StrengthControlVal = SliceQpY of first slice of target picture \div NormQP$$

Furthermore, clip processing may be explicitly performed so that the range of the value is 0 . . . 1.

StrengthControlVal=Clip3(0.0, 1.0, SliceQpY of first slice of target picture÷NormQP) Note that SliceQpY is a value of the quantization parameter in the slice header decoded from the coded data, and is set to 0 in a case of being a negative value. NormQP is a value for normalization, and is a maximum value of the quantization parameter or the maximum value+1. For example, in a case of NPL 1, the maximum value of the quantization parameter is 63, and thus the value of NormQP is 63 or 64. In a case of H.264/AVC and H.265/HEVC, the maximum value of the quantization parameter is 51, and thus the value of NormQP may be 51 or 52.

As another embodiment, on the assumption that the maximum value is luma pixel bit length and StrengthControlValInDecoder=SliceQpY, the following may be derived, using the function InpY:

$$StrengthControlVal = InpY ( StrengthControlValInDecoder )$$

nnpfc_reserved_zero_bit_b is set to 0, and nnpfc_payload_byte[i] conforms to ISO/IEC 15938-17 and is an i-th byte of the bitstream coded with NNC.

nnpfc_out_sub_c_flag indicates the values of variables outSubWidthC and outSubHeightC in a case that (nnpfc_purpose & 0×02) is not 0. In a case that the value of nnpfc_out_sub_c_flag is 1, it indicates that the value of outSubWidthC is 1 and the value of outSubHeightC is 1, that is, the 4:4:4 format. In a case that the value of nnpfc_out_sub_c_flag is 0, it indicates that the value of outSubWidthC is 2 and the value of outSubHeightC is 1, that is, the 4:2:2 format. In a case that the value of ChromaFormatIdc is 2 and that nnpfc_out_sub_c_flag is present, the value of nnpfc_out_sub_c_flag should be 1.

In NPL 3, in a case that the input is in the 4:2:2 format, the chrominance up-sampling is always in the 4:4:4 format, and thus there is a problem of the flag information being redundant. Specifically, in a case that the value of ChromaFormatIdc is 2 and the value of (nnpfc_purpose & 0×02) is not 0, the value of nnpfc_out_sub_c_flag should be 1, and thus there is a problem of the bit of nnpfc_out_sub_c_flag being redundant.

Therefore, in the present embodiment, nnpfc_out_sub_c_flag indicates, as syntax, the values of the variables outSubWidthC and outSubHeightC in a case that the value of (nnpfc_purpose & 0×02) is not 0 and the value of ChromaFormatIdc is 1.

With such syntax, in a case that the value of ChromaFormatIdc is 2, redundant flag information is not transmitted, and thus the redundancies can be reduced.

As another method, nnpfc_out_sub_c_flag may indicate, as syntax, the values of the variables outSubWidthC and outSubHeightC in a case that the value of (nnpfc_purpose & 0×02) is not 0 and the value of SubHeightC is 2.

In addition, as another method, in a case that the value of ChromaFormatIdc is 2 and the value of (nnpfc_purpose 0 & 0×02) is not 0 as semantics, nnpfc_out_sub_c_flag is not sent as syntax, and the value of outSubWidthC is 1 and the value of outSubHeightC is 1, that is, the 4:4:4 format is defined.

According to the present embodiment, in a case that the value of ChromaFormatIdc is 2, redundant flag information is not transmitted, and thus the redundancy can be reduced.

nnpfc_out_colour_format_idc specifies the chroma format of the output in a case that the value of nnpfc_purpose & 0×20 is not 0, and consequently specifies the values of the variables outSubWidthC and outSubHeightC.

The case that the value of nnpfc_out_colour_format_idc is 1 indicates that the colour format of the NNPF outputs is 4:2:0 and both the values of outSubWidthC and outSubHeightC are 2.

The case that the value of nnpfc_out_colour_format_idc is 2 indicates that the colour format of the NNPF outputs is 4:2:2, the value of outSubWidthC is 2, and the value of outSubHeightC is 1.

The case that the value of nnpfc_out_colour_format_idc is 3 indicates that the colour format of the NNPF outputs is 4:4:4 and both the values of outSubWidthC and outSubHeightC are 1.

The value of nnpfc_out_colour_format_idc should not be 0.

In a case that the values of nnpfc_purpose & 0×02 and nnpfc purpose & 0×20 are both 0, the values of outSubWidthC and outSubHeightC should be equal to SubWidthC and SubHeightC, respectively.

nnpfc_inp_order_idc is a format of the input tensor, and indicates a method of ordering the pixel array of the decoded image as an input to the post-filtering processing. Semantics of nnpfc_inp_order_idc in a range of 0 to 3 indicates a process of deriving an input tensor inputTensor for each value of nnpfc_inp_order_idc.

In a case that the value of nnpfc_inp_order_idc is 0, and in a case that the value of nnpfc_auxiliary_inp_idc is 0, only one luma matrix is present in the input tensor of each input image, and the number of channels is 1. Otherwise (in a case that the value of nnpfc_auxiliary_inp_idc is 1), there are one luma matrix and one auxiliary input matrix, and the number of channels is 2.

In a case that the value of nnpfc_inp_order_idc is 1, and in a case that the value of nnpfc_auxiliary_inp_idc is 0, two chroma matrices are present in the input tensor, and the number of channels is 2. Otherwise (in a case that the value of nnpfc_auxiliary_inp_idc is 1), there are two chroma matrices and one auxiliary input matrix, and the number of channels is 3.

In a case that the value of nnpfc_inp_order_idc is 2, and in a case that the value of nnpfc_auxiliary_inp_idc is 0, one luma matrix and two colour matrices are present in the input tensor, and the number of channels is 3. Otherwise (in a case that the value of nnpfc_auxiliary_inp_idc is 1), there are one luma matrix, two chroma matrices, and one auxiliary input matrix, and the number of channels is 4.

In a case that the value of nnpfc_inp_order_idc is 3, and in a case that the value of nnpfc_auxiliary_inp_idc is 0, four luma matrices and two chroma matrices are present in the input tensor, and the number of channels is 6. Otherwise (in a case that the value of nnpfc_auxiliary_inp_idc is 1), there are four luma matrices, two chroma matrices, and one auxiliary input matrix, and the number of channels is 7. nnpfc_inp_order_idc can be used only in a case that the input format is 4:2:0.

The case that the value of nnpfc_auxiliary_inp_idc is greater than 0 indicates that auxiliary input data is present in the input tensor. The case that the value of nnpfc_auxiliary_inp_idc is 0 indicates that auxiliary input data is not present in the input tensor. In a case that the value of nnpfc_auxiliary_inp_idc is 1, the variable strengthControlScaledVal is derived as follows.

```
  if(nnpfc_inp_format_idc == 1)
    StrengthControlScaledVal = Floor(StrengthControlVal * ((1 <<
inpTensorBitDepthY)−1))
  else
    strengthControlScaledVal = StrengthControlVal
```

In NPL 3, the bit length inpTensorBitDepthY of the luma pixel value and the bit length inpTensorBitDepthC of the chroma pixel value in a case that the pixel values input to the neural network of the post-filtering processing are unsigned integers are independently defined. Thus, there is a problem in that definition of the variable strengthControlScaledVal is unclear in a case that the value of inputTensor is an integer value.

In view of this, the supplemental enhancement information decoding apparatus 91 may change whether the bit-depth for luminance is used or the bit depth for chrominance is used for derivation of StrengthControlVal, in accordance with the format nnpfc_inp_order_idc of the input tensor. Furthermore, in a case that the condition (nnpfc_inp_order_idc==0∥nnpfc_inp_order_idc==2∥nnpfc_inp_order_idc==3) is true, derivation may be performed using the pixel bit length for luminance (luminance-prioritized configuration). Otherwise, StrengthControlVal may be derived using the bit depth of chrominance.

```
  if (nnpfc_inp_format_idc==1) {
    if (nnpfc_inp_order_idc==0 || napfc_inp_order_idc==2 || nnpfc_inp
_order_id==3)
      strengthControlScaledVal=Floor(StrengthControlVal*((1 <<
inpTensorBitDepthY)−1))
    else if (nnpfc_inp_order_idc == 1)
      strengthControlScaledVal=Floor(StrengthControlVal*((1 <<
inpTensorBitDepthC)−1))
  }
```

As another method, in a case that the condition (nnpfc_inp_order_idc==1) is true, the value may be derived by using pixel bit length of chrominance (chrominance-prioritized configuration). Otherwise, StrengthControlVal may be derived using the bit depth of luminance.

```
  if (nnpfc_inp_format_idc=1) {
    if (nnpfc_inp_order_idc==1)
      strengthControlScaledVal=Floor(StrengthControlVal*((1 <<
inpTensorBitDepthC)−1))
    else
      strengthControlScaledVal=Floor(StrengthControlVal*((1 <<
inpTensorBitDepthY)−1))
  }
```

Note that the variable strengthControlScaledVal is input as one channel of the input tensor as an input of the auxiliary input matrix.

### Neural Network Post-Filter Activation (NNPFA) SEI

FIG. 8 illustrates syntax of the neural network post-filter activation (NNPFA) SEI message. The neural network post-filter activation NNPFA SEI message activates or deactivates application of target neural network post-filtering processing identified by nnpfa_target_id for the post-filtering processing of a series of pictures.

nnpfa_target_id indicates the neural network post-filtering processing of a target picture. This specifies one or more NNPFC SEI messages having nnpfc_id equal to_target_id for the current picture.

Unless one or both of the following conditions are true, the NNPFA SEI message having a specific value of nnpfa_target_id must not be present in the current PU.
In the current CLVS, there is an NNPFC SEI message having nnpfc_id equal to the specific value of nnpfa_target_id present in the PU prior to the current PU in decoding order.
There is an NNPFC SEI message having nnpfc_id equal to the specific value of nnpfa_target_id of the current PU.

In a case that both of the NNPFC SEI message having a specific value of nnpfc_id in the PU and the NNPFA SEI message having nnpfa_target_id equal to the specific value of nnpfc_id are included, the NNPFC SEI message is prior to the NNPFA SEI message in decoding order.

In a case that nnpfa_cancel_flag is 1, continuity of the target neural network post-filtering processing configured by a previous NNPFA SEI message having the same nnpfa_target_id as the current SEI message is to be cancelled. In other words, the target neural network post-filtering processing is not performed.

A case that the same nnpfa_target_id as the current SEI message is provided and nnpfa_cancel_flag is 0, the target neural network post-filtering processing is not used as long as it is not activated by another NNPFA SEI message. In a case that nnpfa_cancel_flag is 0, it indicates that nnpfa_persistence_flag continues.

_persistence_flag indicates that the target neural network post-filtering processing of the current layer continues in display output order.

In a case that nnpfa_persistence_flag is 0, it indicates that the target neural network post-filtering processing is applied to the post-filtering processing of only the current picture.

In a case that nnpfa_persistence_flag is 1, it indicates that the target neural network post-filtering processing is applied to the post-filtering processing of the current image and all of the subsequent pictures of the current layer, until one or more of the following conditions become true.
A new CLVS of the current layer starts.
The bitstream ends.
The image of the current layer associated with the NNPFA SEI message having the same nnpfa_target_id as the current SEI message and nnpfa_cancel_flag equal to 1 is output after the current image in display output order.

Note that, in a case that the same nnpfa_target_id as the current SEI message is provided and nnpfa_cancel_flag is 1, the neural network post-filtering processing is not applied to subsequent pictures of the current layer associated with the NNPFA SEI message.

In NPL 2, by setting nnpfa_persistence_flag to 1, it is possible to continue the post-filtering processing without sending the NNPFA SEI to the subsequent pictures in the display output order. However, in a case that the coding and decoding order is different from the display output order, for example, and a case that a prediction structure such as a so-called hierarchical B structure (hierarchical bi-prediction structure) is adopted, it is difficult for a supplemental enhancement information generating apparatus 71 to generate supplemental enhancement information of NNPFA SEI.

At the time at which it is attempted to generate the supplemental enhancement information of the NNPFA SEI, it is generally considered to determine whether to perform the post-filtering processing and which neural network model is to be used in the coding order (=decoding order), whereas it is necessary to generate NNPFA SEI so that it can be determined whether the post-filtering processing is continuous in the display output order. In this case, whether the post-filtering processing by the same neural network model is continuous in the display output order cannot be determined at the timing of coding on a per picture basis unless it is known in advance whether the post-filtering processing is performed on pictures and which model is to be used.

In such a case, it is necessary to set nnpfa_persistence_flag to 0 and send (always transmit) the NNPFA SEI for all pictures for which the post-filtering processing is activated, or to create the supplemental enhancement information after delay until the display output order is determined, code the supplemental enhancement information, and output the coded data.

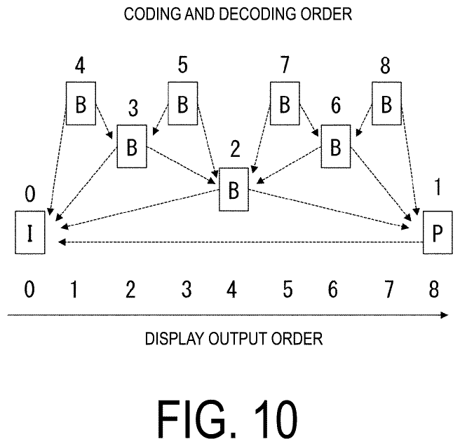

Specifically, FIG. 10 illustrates an example of the hierarchical B structure as an example of a prediction structure in which the display output order and the coding and decoding order are different. The 8th picture P in the display output order is the first picture in the coding and decoding order. On the other hand, the 7th picture B in the display output order is the eighth picture in the coding and decoding order. In the case of post-filtering processing for image quality improvement, whether to apply post-filtering processing is determined on a per picture basis immediately after coding. However, in a case that post-filtering processing is activated at the 8th picture P in the display output order, the 7th picture B that is one before the 8th picture in the display output order is the 8th picture in the coding and decoding order, thus it is not subject to the coding and decoding processing, and it is not known whether post-filtering processing is continued.

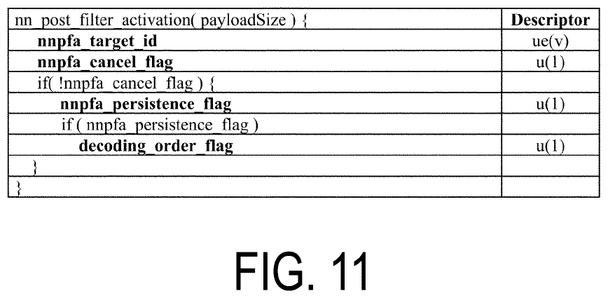

Therefore, in a case that the value of nnpfa_persistence_flag is 1 as illustrated in FIG. 11 in the syntax of NNPA SEI in the present embodiment, the syntax element decoding_order_flag is coded and decoded. The case that decoding_order_flag is 1 indicates that the post-filtering processing of the picture continues in the decoding order (coding order). The case that decoding_order_flag is 0 indicates that the post-filtering processing of the picture continues in the display output order.

With this configuration, in a case that the coding and decoding order and the display output order are different, it is possible to set decoding_order_flag to 1 and create supplemental enhancement information indicating that the post-filtering processing continues in the coding and decoding order.

As another solution, with output_order_flag instead of decoding_order_flag, the case that output_order_flag is 1 indicates that post-filtering processing of pictures continues in the display output order. The case that output_order_flag is 0 indicates that the post-filtering processing of the pictures continues in the decoding order (coding order).

In addition, as another solution, a syntax element called nnpfa_presistence_idc is defined instead of nnpfa_presistence_flag, a value of 0 with a descriptor of ue(v) indicates that the target neural network post-filtering processing is applied to post-filtering processing of the current picture only. The case where the value of nnpfa_presistence_idc is 1 indicates that post-filtering processing of the pictures continues in the display output order, and the case where the value of nnpfa_presistence_idc is 2 indicates that the post-filtering processing of the pictures continues in the decoding order (coding order).

In addition, as another solution, there is a method of describing decoding_order_flag and output_order_flag in the NNPFC SEI. In this case, the syntax of FIG. 8 is used without changing the NNPFA SEI.

According to the present embodiment, even in a case that the coding and decoding order is different from the display output order, it is possible to efficiently activate the post-filtering processing on a per picture basis.

The supplemental enhancement information generating apparatus 71, the supplemental enhancement information coding apparatus 81, and the supplemental enhancement information decoding apparatus 91 may store a general-purpose network parameter in common. The supplemental enhancement information generating apparatus 71 generates a network parameter for partially updating the general-purpose network stored in common as the supplemental enhancement information, using a framework such as the neural network post-filter characteristics SEI. Then, the supplemental enhancement information coding apparatus 81 may perform coding, and the supplemental enhancement information decoding apparatus 91 may perform decoding. With such a configuration, the amount of codes of the supplemental enhancement information can be reduced, and the supplemental enhancement information in accordance with the input image T can be generated, coded, and decoded.

In addition, as a transmission format of the network parameter, a parameter (identifier) indicating a format may be transmitted in order to support multiple formats. Actual supplemental enhancement information following the identifier may be transmitted in a byte string.

The supplemental enhancement information of the network parameter decoded in the supplemental enhancement information decoding apparatus 91 is input to the post-filtering processing apparatus 61.

Using the decoded supplemental enhancement information (neural network post-filter characteristics SEI, neural network post-filter activation SEI), the post-filtering processing apparatus 61 performs post-image processing using the neural network, and restores a decoded video Td.

The supplemental enhancement information coding apparatus 81 codes the supplemental enhancement information based on the syntax tables of FIGS. 7, 8, 9, and 11. The supplemental enhancement information is coded as the supplemental enhancement information SEI, multiplexed on the coded data Te output by the image coding apparatus 11, and output to the network 21.

The supplemental enhancement information decoding apparatus 91 decodes the supplemental enhancement information from the coded data Te, based on the syntax tables of FIGS. 7, 8, 9, and 11, and transmits the decoded results to the post-filtering processing apparatus 61. The supplemental enhancement information decoding apparatus 91 decodes the supplemental enhancement information coded as the supplemental enhancement information SEI.

The post-filtering processing apparatus 61 performs the post-image processing on the decoded video Td, using the decoded video Td and the supplemental enhancement information, and generates post-image processing To.

The supplemental enhancement information generating apparatus 71, the supplemental enhancement information coding apparatus 81, and the supplemental enhancement information decoding apparatus 91 may store a general-purpose network parameter in common. The supplemental enhancement information generating apparatus 71 may generate a network parameter for partially updating the general-purpose network stored in common as the supplemental enhancement information, the supplemental enhancement information coding apparatus 81 may perform coding, and the supplemental enhancement information decoding apparatus 91 may perform decoding. With such a configuration, the amount of codes of the supplemental enhancement information can be reduced, and the supplemental enhancement information in accordance with the input image T can be generated, coded, and decoded.

In addition, as a transmission format of the network parameter, a parameter (identifier) indicating a format may be transmitted in order to support multiple formats. Actual supplemental enhancement information following the identifier may be transmitted in a byte string.

The supplemental enhancement information of the network parameter decoded in the supplemental enhancement information decoding apparatus 91 is input to the post-filtering processing apparatus 61.

Note that, in an example of the present embodiment, syntax with SEI is described; however, the SEI is not restrictive, and syntax such as the SPS, the PPS, the APS, and the slice header may be used.

In the present embodiment, in such a configuration, even in a case that a transmission rate is low, a method for enabling improvement of image quality and efficient coding and decoding of the supplemental enhancement information regardless of a prediction structure is provided. Post-filter Hint SEI

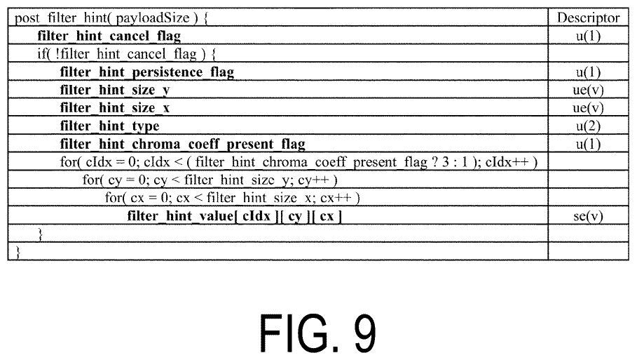

FIG. 9 illustrates the syntax of post-filter hint SEI described in NPL. This SEI message provides a coefficient of the post-filter or correlation information for the design of the post-filter. After a picture is decoded and output, the picture can be post-processed to improve the image quality.

The following variables are defined to use the post-filter hint SEI message.
The variable CroppedWidth as a width value and the variable CroppedHeight as a height value of the decoded image of the luma pixels to be output.
ChromaFormatIdc is a variable indicating a chroma format, and the value 0 indicates monochrome, the value 1 indicates the 4:2:0 format, the value 2 indicates 4:2:2 format, and the value 3 indicates 4:4:4 format, respectively.
Variable BitDepthY indicating a pixel bit length of a luma pixel of the output decoded image.
Variable BitDepthC indicating a pixel bit length of a chroma pixel of the output decoded image.
Pixel array CroppedSampleArray [cIdx] of the cIdx-th component of the output decoded image indicates the component of the luminance Y in a case that the value of cIdx is 0, indicates the component of the chrominance Cb in a case that the value of cIdx is 1, and indicates the component of the chrominance Cr in a case that the value of cIdx is 2.
The variables SubWidthC and SubHeightC are derived according to the value of ChromaFormatIdc. In a case that the value of ChromaFormatIdc is 0, that is, in a case of monochrome, the values of SubWidthC and SubHeightC are both 0. In a case that the value of ChromaFormatIdc is 1, that is, in the case of 4:2:0 format, the values of SubWidthC and SubHeightC are both 2. In a case that the value of ChromaFormatIdc is 2, that is, in the case of 4:2:2 format, the value of SubWidthC is 2 and the value of SubHeightC is 1. In a case that the value of ChromaFormatIdc is 3, that is, in the case of 4:4:4 format, the values of SubWidthC and SubHeightC are both 1.

The case that filter_hint_cancel_flag is 1 indicates that the SEI message cancels the continuity of the previous post-filter hint SEI message in the output order that is applied to the current layer.

The case that filter_hint_cancel_flag is 0 indicates that the post-filter hint information continues.

filter_hint_persistence_flag specifies the continuity of the post-filter hint SEI message of the current layer.

The case that filter_hint_persistence_flag is 0 indicates that the post-filter hint SEI is applied only to the current decoded image.

The case that filter_hint_persistence_flag is 1 indicates that the post-filter SEI message is applied to the current decoded picture and persists for all subsequent pictures of the current layer in the output order until one or more of the following conditions are true.
A new CLVS of the current layer starts.
A bitstream ends.
The picture of the current layer of the AU associated with the post-filter hint SEI message is the output following the current picture in the output order.

filter_hint_size_y specifies the size of a filter coefficient or a correlation array in the vertical direction.

The value of filter_hint_size_y ranges from 1 to 15. filter_hint_size_x specifies the size of a filter coefficient or a correlation array in the horizontal direction.

The value of filter_hint_size_x ranges from 1 to 15. filter_hint_type identifies the type of a transmitted post-filter hint. The case that the value of filter_hint_type is 0 indicates that the filter coefficient is of a two-dimensional FIR filter. The case that the value of filter_hint_type is 1 indicates that the filter coefficient is of a one-dimensional FIR filter. The case that the value of filter_hint_type is 2 indicates a cross correlation matrix. A value of filter_hint_type is required to be in the range of 0 to 2. In a case that the value of filter_hint_type is 3, it is reserved for future use. In a case that filter_hint_type is 3, it is assumed that the post-filter hint SEI message is ignored.

The case that the value of filter_hint_chroma_coeff_present_flag is 1 indicates the presence of a chrominance filter coefficient. The case that the value of filter_hint_chroma_coeff_present_flag is 0 indicates the absence of chrominance filter coefficients.

filter_hint_value[cIdx][cy][cx] indicates the filter coefficients or elements of the cross correlation matrix between the original and decoded signals with 16-bit accuracy. The value of filter_hint_value[cIdx][cy][cx] ranges from minus 2 to the 31st power plus 1 to 2 to the 31st power plus 1. cIdx represents a component, and the case that the value of cIdx is 0 indicates an element for a luma pixel, the case that the value is 1 indicates an element for a chroma pixel Cb, and the case that the value is 2 indicates an element for a chroma pixel Cr. cy represents a vertical-direction counter and cx represents a horizontal-direction counter. The following is applied depending on the value of filter_hint_type.

In the case that the value of filter_hint_type is 0, the coefficients of a two-dimensional finite impulse response (FIR) filter in the size of filter_hint_size_y*filter_hint_size_x are transmitted.

In a case that the value of filter_hint_type is 1, the filter coefficients of two one-dimensional FIR filters are transmitted. In this case, the value of filter_hint_size_y should be 2. The case that the value of the index cy is 0 indicates the filter coefficient of the horizontal filter, and the case that the value of the index cy is 1 indicates the filter coefficient of the vertical filter. In the filtering process, the horizontal filter is first applied, and the result is filtered by the vertical filter.

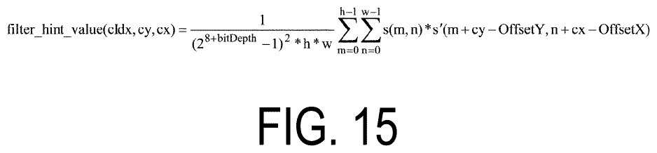

The case that the value of filter_hint_type is 2 indicates that the transmitted hint information is a cross correlation matrix between the original signal s and the decoded signal s′. Note that the normalized cross correlation matrix of an associated component with the size of filter_hint_size_y*filter_hint_size_x identified by cIdx is defined by the formula shown in FIG. 15.

Here, s represents the array of pixels of the component cIdx of the original image, and s′ represents CroppedSampleArray [cIdx]. h is the value of CroppedHeight in a case that the value of cIdx is 0, and the value of CroppedHeight/SubHeightC in a case that the value of cIdx is greater than 0. w is the value of CroppedWeight in a case that the value of cIdx is 0, and the value of CroppedWidth/SubWidthC in a case that the value of cIdx is greater than 0.

bitDepth is set to the value of BitDepthY in a case that the value of cIdx is 0, and is set to the value of BitDepthC in a case that the value of cIdx is greater than 0.

In a case that cIdx is greater than 0, OffsetY is (filter_hint_size_y>>1), OffsetX is (filter_hint_size_x>>1), and 0<=cy<filter_hint_size_y and 0<=cx<filter_hint_size_x.

Note that the supplemental enhancement information decoding apparatus 91 can derive a Wiener filter from a cross correlation matrix of the original signal and the decoded signal and an autocorrelation matrix of the decoded signal.

In NPL 3, although the filter coefficient itself is transmitted at filter_hint_value in a case that the value of filter_hint_type is 0 or 1, there is a problem that the pixel bit length of the filtered image is unclear.

Therefore, in a case that filter_hint_type is 0 or 1, the pixel bit length of the filtered image is derived with the following formula using the sum filtSum of the filter_hint_value [m][n] wherein m=0, . . . , h−1 and n=0, . . . , w−1.

filtSum=bitDepth+Ceil(Log 2(filtSum))

In NPL 3, in the formula of FIG. 15 defining the cross correlation matrix in a case that the value of filter_hint_type is 2, the values of the cross correlation matrix are normalized by dividing them by the product of the square of the value of (2 to the power of (8+bitDepth) minus 1) and the number of pixels. Therefore, there was a problem that the value of each element of the matrix becomes very small.

In addition, there was a problem that the processing of the edge parts of the picture was not taken into consideration, and the definition formula resulted in accessing outside the picture of the decoded image s′.

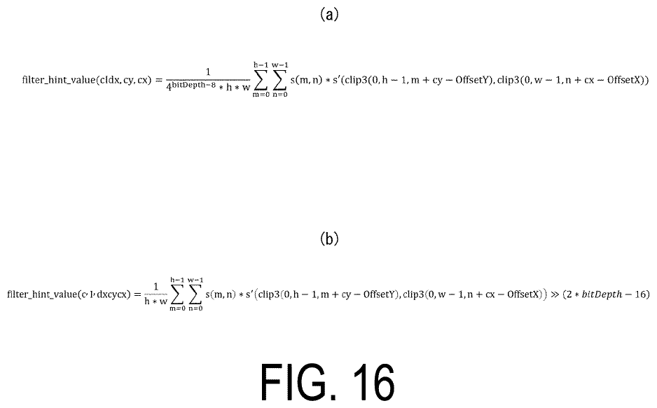

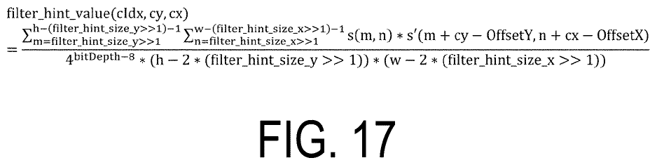

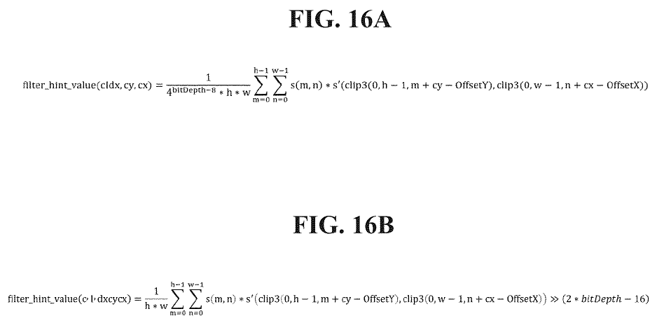

Therefore, in the present embodiment, as in the formula shown in FIG. 16(a), a value of 4 to the power of (bitDepth−8) is used instead of the square of the value of (2 to the power of (8+bitDepth)) minus 1. This makes it possible to suppress the value of each element of the matrix to 16-bit accuracy independent of the pixel bit length. Alternatively, as in the formula shown in FIG. 16(b), an operation of performing a right shift of (2*bitDepth−16) bits may be used instead of the division.

In a case that the value of each element of the matrix is set at a 32-bit accuracy, a method of eliminating division of a value related to bitDepth, that is, a formula for normalizing only the number of pixels h*w may be used.

Furthermore, clipping processing is added so that only pixels in the picture are accessed. In Clip3 (0, h−1, m+cy−OffsetY), the pixel positions that are less than the top edge or greater than the bottom edge of the picture are replaced with the pixel positions at the top edge and bottom edge of the picture, respectively (padding is applied). Similarly, in Clip3 (0, w−1, n+cx−OffsetX), the pixel positions that are less than the left edge or greater than the right edge of the picture are replaced with the pixel positions at the left edge and the right edge of the picture, respectively (padding is applied).

As another method, the cross correlation matrix may be obtained only in the picture of the decoded image s′ as shown in the formula of FIG. 17, instead of the clipping processing. In this case, m is not 0 to h−1, but (filter_hint_size_y>>1) to h−1−(filter_hint_size_y>>1), and n is not 0 to w−1 but (filter_hint_size_x>>1) to w−1−(filter_hint_size_x>>1). Therefore, the number of pixels used in the calculation is (h−2*(filter_hint_size_y>>1))*(w−2*(filter_hint_size_x>>1)).

In addition, there are several methods other than the clipping processing in which it is assumed that the pixels at the picture edges are extended to the outside of the picture without change. For example, reflection padding may be used, which assumes that pixels are extended from an edge of the picture in a mirror surface manner. The padding may be wrap-around padding on the assumption that the pixels are continuous with pixels at the edge of the picture on the opposite side. The padding may be fixed padding in which padding is performed with a fixed value, for example, a value of (1<< (BitDepth−1)) with respect to the pixel bit length BitDepth. A method of padding a value of 0 may be used.

Note that a computer may be used to implement some of the image coding apparatus 11 and the image decoding apparatus 31 in the above-described embodiments, for example, the entropy decoder 301, the parameter decoder 302, the loop filter 305, the prediction image generation unit 308, the inverse quantization and inverse transform processing unit 311, the addition unit 312, the prediction parameter derivation unit 320, the prediction image generation unit 101, the subtraction unit 102, the transform and quantization unit 103, the entropy coder 104, the inverse quantization and inverse transform processing unit 105, the loop filter 107, the coding parameter determination unit 110, the parameter coder 111, and the prediction parameter derivation unit 120. In that case, this configuration may be realized by recording a program for realizing such control functions on a computer-readable recording medium and causing a computer system to read and perform the program recorded on the recording medium. Note that the “computer system” mentioned here refers to a computer system built into either the image coding apparatus 11 or the image decoding apparatus 31 and is assumed to include an OS and hardware components such as a peripheral apparatus. In addition, the “computer-readable recording medium” refers to a portable medium such as a flexible disk, a magneto-optical disk, a ROM, and a CD-ROM, and a storage apparatus such as a hard disk built into the computer system. Moreover, the “computer-readable recording medium” may include a medium that dynamically stores a program for a short period of time, such as a communication line in a case that the program is transmitted over a network such as the Internet or over a communication line such as a telephone line, and may also include a medium that stores the program for a certain period of time, such as a volatile memory included in the computer system functioning as a server or a client in such a case. In addition, the above-described program may be one for implementing some of the above-described functions, and also may be one capable of implementing the above-described functions in combination with a program already recorded in a computer system.

In addition, a part or all of the image coding apparatus 11 and the image decoding apparatus 31 in the embodiments described above may be implemented as an integrated circuit such as a Large Scale Integration (LSI). Function blocks of the image coding apparatus 11 and the image decoding apparatus 31 may be individually realized as processors, or some or all of the function blocks may be integrated into processors. In addition, the circuit integration technique is not limited to LSI, and implementation as a dedicated circuit or a multi-purpose processor may be adopted. In addition, in a case that a circuit integration technology that replaces LSI appears as the semiconductor technologies advance, an integrated circuit based on that technology may be used.

Although embodiments of the present invention have been described above in detail with reference to the drawings, the specific configurations thereof are not limited to those described above and various design changes or the like can be made without departing from the spirit of the invention.

### Application Example

The video coding apparatus 10 and the video decoding apparatus 30 described above can be installed and used in various apparatuses performing transmission, reception, recording, and playback of videos. Further, a video may be a natural video imaged by a camera or the like, or may be an artificial video (including CG and GUI) generated by a computer or the like.

### SEI Payload

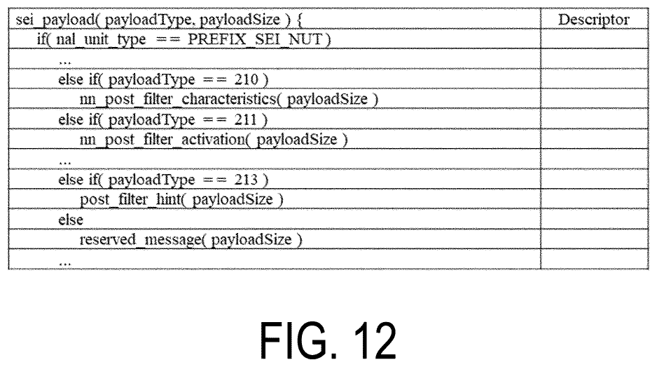

FIG. 12 is a diagram illustrating syntax of an SEI payload being a container of an SEI message.

nal_unit_type is called in a case of PREFIX_SEI_NUT. PREFIX_SEI_NUT indicates that SEI is SEI located before slice data.

In a case that payloadType is 210, the neural network post-filter characteristics SEI is called.

In a case that payloadType is 211, the neural network post-filter activation SEI is called.

In a case that payloadType is 213, the post-filter hint SEI is called.

### Decoding of SEI and Post-Filtering Processing

The header decoder 3020 reads the SEI payload being a container of the SEI message, and decodes the neural network post-filter characteristics SEI message. For example, the header decoder 3020 decodes nnpfc_id, nnpfc_mode_idc, nnpfc_formatting_and_purpose_flag, nnpfc_purpose, nnpfc_reserved_zero_bit_a, nnpfc_uri_tag[i], nnpfc_uri[i], nnpfc_reserved_zero_bit_b, and nnpfc_payload_byte[i].

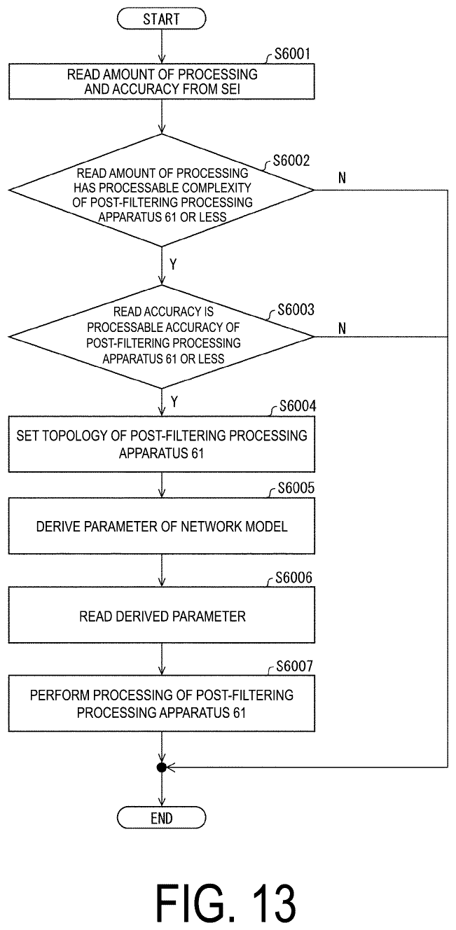

FIG. 13 is a diagram showing the flowchart of processing of the post-filtering processing apparatus 61. The post-filtering processing apparatus 61 performs the following processing in accordance with parameters of the SEI message.

S6001: Read the amount of processing and accuracy from the SEI.

S6002: End in a case that the amount of post-processing has complexity exceeding processable complexity. In a case that it does not exceed the processable complexity, proceed to S6003.

S6003: End in a case that the accuracy exceeds processable accuracy of the post-filtering processing apparatus 61. In a case that it does not exceed the processable accuracy, proceed to S6004.

S6004: Identify a network model from the SEI, and set topology of the post-filtering processing apparatus 61.

S6005: Derive the parameters of the network model from update information of the SEI.

S6006: Read the derived parameters of the network model in the post-filtering processing apparatus 61.

S6007: Perform filter processing of the post-filtering processing apparatus 61, and output to the outside.

Note that the SEI is not necessarily required for construction of a luminance sample and a chroma sample in decoding processing.

### Details of Post-Filtering Processing Apparatus 61

An NN filter unit performs the filter processing by the neural network model, using an input image inputTensor and input parameters (for example, QP, bS, and the like). The input image may be an image for each component or may be an image having multiple components as channels. The input parameters may be assigned to a different channel from the image.

The NN filter unit may repeatedly apply the following processing.

The NN filter unit performs convolution operation (conv, convolution) of a kernel k[m][i][j] on inputTensor, and derives an output image outputTensor to which bias is added. Here, nn=0 . . . n−1, xx=0 . . . width−1, and yy=0 . . . height−1, and Σ represents the sum for each of mm, i, and j.

$$outputTensor [ nn ] [ xx ] [ yy ] = ΣΣΣ ( k [ m m ] [ i ] [ j ] * inputTensor [ m m ] [ xx + i - of ] [ yy + j - of ] + bias [ nn ] )$$

In a case of 1×1 Conv, Σ represents the sum for each of mm=0 . . . m−1, i=0, and j=0. In this case, of =0 is set. In a case of 3×3 Conv, Σ represents the sum for each of mm=0 . . . m−1, i=0 . . . 2, and j=0 . . . 2. In this case, of =1 is set. n represents the number of channels of outSamples, m represents the number of channels of inputTensor, width represents the width of inputTensor and outputTensor, and height represents the height of inputTensor and outputTensor. of represents the size of a padding area provided around inputTensor in order to make inputTensor and outputTensor have the same size. In the following, in a case that output of the NN filter unit is a value (correction value) instead of an image, corrNN is used to represent output instead of outputTensor.

Note that, in a case of description using inputTensor and outputTensor of the CHW format instead of inputTensor and outputTensor of the CWH format, it is equivalent to the following processing.

$$outputTensor [ nn ] [ yy ] [ xx ] = ΣΣΣ ( k [ m m ] [ i ] [ j ] * inputTensor [ m m ] [ yy + j - of ] [ xx + i - of ] + bias [ nn ] )$$

Processing shown by the following expression referred to as Depth wise Conv may be performed. Here, nn=0 . . . n−1, xx=0 . . . width−1, and yy=0 . . . height−1, and 2 represents the sum for each of i and j. n represents the number of channels of outputTensor and inputTensor, width represents the width of inputTensor and outputTensor, and height represents the height of inputTensor and outputTensor.

$$outputTensor [ nn ] [ xx ] [ yy ] = ΣΣ ( k [ nn ] [ i ] [ j ] * inputTensor [ nn ] [ xx + i - of ] [ yy + j - of ] + bias [ nn ] )$$

Non-linear processing referred to as Activate, such as ReLU, may be used.

$$ReLU ( x ) = x >= 0 ? x : 0 x : 0$$

Alternatively, leakyReLU shown in the following formula may be used.

$$leakyReLU ( x ) = x >= 0 ? x : a * x$$

Here, a is a prescribed value, for example, 0.1 or 0.125. In order to perform integer arithmetic, all of the above values of k, bias, and a may be integers, and right shifting may be performed after conv.

ReLU always outputs 0 for values less than 0 and directly outputs input values as they are for values equal to or greater than 0. In contrast, in leakyReLU, for values less than 0, linear processing is performed with a gradient being set equal to a. In ReLU, the gradient for values less than 0 disappears, and learning may not advance steadily. leakyReLU leaves a gradient for values less than 0, making such a problem less likely to occur. Of above leakyReLU (x), PRELU using a parameterized value of a may be used.

### NNC

Neural Network Coding (NNC) is international standard ISO/IEC 15938-17 for efficiently compressing a neural network (NN). Compressing a learned NN enables enhanced efficiency in storing and transmitting the NN.

In the following, an overview of coding and decoding processing of NNC will be described.

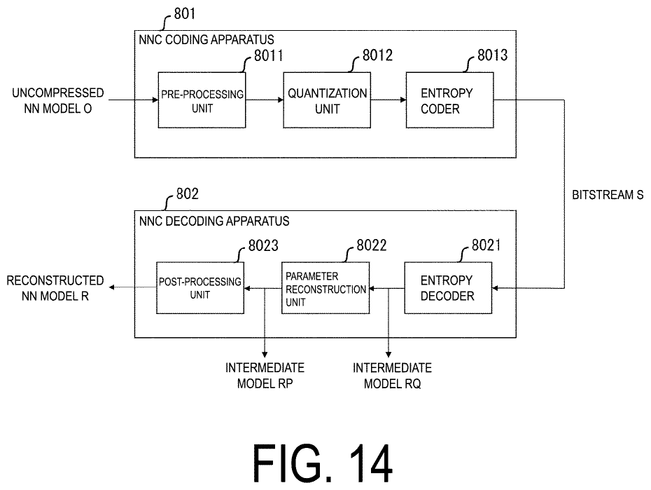

FIG. 14 is a diagram illustrating a coding apparatus and a decoding apparatus for NNC.

An NN coding apparatus 801 includes a pre-processing unit 8011, a quantization unit 8012, and an entropy coder 8013. The NN coding apparatus 801 inputs an uncompressed NN model O, performs quantization of the NN model O in the quantization unit 8012, and derives a quantized model Q. Before the quantization, the NN coding apparatus 801 may repeatedly apply parameter reduction methods in the pre-processing unit 8011, such as pruning and sparse representation. Subsequently, in the entropy coder 8013, entropy coding is applied to the quantized model Q, and a bitstream S for storing and transmitting the NN model is derived.

An NN decoding apparatus 802 includes an entropy decoder 8021, a parameter reconstruction unit 8022, and a post-processing unit 8023. The NN decoding apparatus 802 first inputs the transmitted bitstream S, and in the entropy decoder 8021, performs entropy decoding of S and derives an intermediate model RQ. In a case that an operating environment of the NN model supports inference using a quantization representation used in RQ, RQ may be output and used for the inference. Otherwise, parameters of RQ are restored to the original representation in the parameter reconstruction unit 8022, and an intermediate model RP is derived. In a case that a sparse tensor representation to be used can be processed in the operating environment of the NN model, RP may be output and used for the inference. Otherwise, a tensor different from the NN model O or a reconfiguration NN model R not including a structural representation is derived and output.

In the NNC standard, there are decoding schemes for numerical representation of specific NN parameters, such as integers and floating points.

With a decoding scheme NNR_PT_INT, a model including a parameter of an integer value is decoded. With a decoding scheme NNR_PT_FLOAT, NNR_PT_INT is enhanced, and a quantization step size delta is added. delta is multiplied by the integer value, and a scaled integer is thereby generated. delta is derived as follows, using a quantization parameter qp of an integer and a granularity parameter qp_density of delta.

$$mul = 2 \hat{} ( qp\_density ) + qp \& ( 2 \hat{} ( qp\_density ) - 1 ) )$$

$$delta = mul * 2 \hat{} ( ( qp ≫ qp\_density ) - qp\_density )$$

### Format of Learned NN

Representation of a learned NN includes two elements, i.e., topology representation such as the size of each layer and connection between the layers and parameter representation such as the weight and the bias.

The topology representation is covered by native formats such as TensorFlow (trade name) and PyTorch (trade name); however, for the sake of enhancement of interoperability, there are exchange formats such as an Open Neural Network Exchange Format (ONNX) (trade name) and a Neural Network Exchange Format (NNEF).

In the NNC standard, topology information nnr_topology_unit_payload is transmitted as a part of an NNC bitstream including a compressed parameter tensor. This allows for implementation of interoperation with topology information represented not only in an exchange format but also in a native format.

### Configuration of Image Coding Apparatus

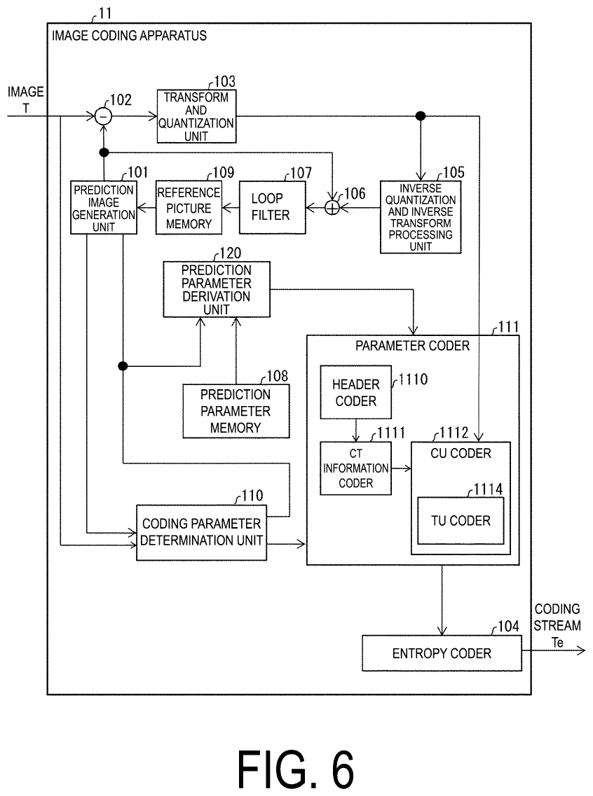

Next, a configuration of the image coding apparatus 11 according to the present embodiment will be described. FIG. 6 is a block diagram illustrating a configuration of the image coding apparatus 11 according to the present embodiment. The image coding apparatus 11 includes a prediction image generation unit 101, a subtraction unit 102, a transform and quantization unit 103, an inverse quantization and inverse transform processing unit 105, an addition unit 106, a loop filter 107, a prediction parameter memory (a prediction parameter storage unit or a frame memory) 108, a reference picture memory (a reference image storage unit or a frame memory) 109, a coding parameter determination unit 110, a parameter coder 111, a prediction parameter derivation unit 120, and an entropy coder 104.

The prediction image generation unit 101 generates a prediction image for each CU.

The subtraction unit 102 subtracts a pixel value of the prediction image of a block input from the prediction image generation unit 101 from a pixel value of an image T to generate a prediction error. The subtraction unit 102 outputs the prediction error to the transform and quantization unit 103.

The transform and quantization unit 103 performs a frequency transform on the prediction error input from the subtraction unit 102 to calculate a transform coefficient, and derives a quantized transform coefficient by quantization. The transform and quantization unit 103 outputs the quantized transform coefficient to the parameter coder 111 and the inverse quantization and inverse transform processing unit 105.

The inverse quantization and inverse transform processing unit 105 is the same as the inverse quantization and inverse transform processing unit 311 (FIG. 6) in the image decoding apparatus 31, and descriptions thereof are omitted. The calculated prediction error is output to the addition unit 106.

The parameter coder 111 includes a header coder 1110, a CT information coder 1111, and a CU coder 1112 (prediction mode coder). The CU coder 1112 further includes a TU coder 1114. General operation of each module will be described below.

The header coder 1110 performs coding processing of parameters such as header information, split information, prediction information, and quantized transform coefficients.

The CT information coder 1111 codes the QT and MT (BT, TT) split information and the like.

The CU coder 1112 codes the CU information, the prediction information, the split information, and the like.

In a case that a prediction error is included in the TU, the TU coder 1114 codes the QP update information and the quantization prediction error.

The CT information coder 1111 and the CU coder 1112 supply, to the parameter coder 111, syntax elements such as an inter prediction parameter and the quantized transform coefficient.

The parameter coder 111 inputs the quantized transform coefficient and the coding parameters to the entropy coder 104. The entropy coder 104 performs entropy coding of the coefficients and parameters to generate and output coded data Te.

The prediction parameter derivation unit 120 derives the inter prediction parameter and an intra prediction parameter from the parameters input from the coding parameter determination unit 110. The inter prediction parameter and intra prediction parameter derived are output to the parameter coder 111.

The addition unit 106 adds, for each pixel, the pixel value for the prediction block input from the prediction image generation unit 101 and the prediction error input from the inverse quantization and inverse transform processing unit 105 to generate a decoded image. The addition unit 106 stores the generated decoded image in the reference picture memory 109.

The loop filter 107 applies a deblocking filter, an SAO, and an ALF to the decoded image generated by the addition unit 106. Note that the loop filter 107 need not necessarily include the above-described three types of filters, and may include only a deblocking filter, for example.

The prediction parameter memory 108 stores the prediction parameters generated by the coding parameter determination unit 110 at a predetermined position for each target picture and CU.

The reference picture memory 109 stores the decoded image generated by the loop filter 107 at a predetermined position for each target picture and CU.

The coding parameter determination unit 110 selects one set among multiple sets of coding parameters. The coding parameters include QT, BT, or TT split information described above, a prediction parameter, or a parameter to be coded which is generated in relation to the aforementioned elements. The prediction image generation unit 101 generates a prediction image by using these coding parameters.

Note that a computer may be used to implement some of the image coding apparatus 11 and the image decoding apparatus 31 in the above-described embodiments, for example, the entropy decoder 301, the parameter decoder 302, the loop filter 305, the prediction image generation unit 308, the inverse quantization and inverse transform processing unit 311, the addition unit 312, the prediction parameter derivation unit 320, the prediction image generation unit 101, the subtraction unit 102, the transform and quantization unit 103, the entropy coder 104, the inverse quantization and inverse transform processing unit 105, the loop filter 107, the coding parameter determination unit 110, the parameter coder 111, and the prediction parameter derivation unit 120. In that case, this configuration may be realized by recording a program for realizing such control functions on a computer-readable recording medium and causing a computer system to read and perform the program recorded on the recording medium. Note that the “computer system” mentioned here refers to a computer system built into either the image coding apparatus 11 or the image decoding apparatus 31 and is assumed to include an OS and hardware components such as a peripheral apparatus. In addition, the “computer-readable recording medium” refers to a portable medium such as a flexible disk, a magneto-optical disk, a ROM, and a CD-ROM, and a storage apparatus such as a hard disk built into the computer system. Moreover, the “computer-readable recording medium” may include a medium that dynamically stores a program for a short period of time, such as a communication line in a case that the program is transmitted over a network such as the Internet or over a communication line such as a telephone line, and may also include a medium that stores the program for a certain period of time, such as a volatile memory included in the computer system functioning as a server or a client in such a case. In addition, the above-described program may be one for implementing some of the above-described functions, and also may be one capable of implementing the above-described functions in combination with a program already recorded in a computer system.

In addition, a part or all of the image coding apparatus 11 and the image decoding apparatus 31 in the embodiments described above may be implemented as an integrated circuit such as a Large Scale Integration (LSI). Function blocks of the image coding apparatus 11 and the image decoding apparatus 31 may be individually realized as processors, or some or all of the function blocks may be integrated into processors. In addition, the circuit integration technique is not limited to LSI, and implementation as a dedicated circuit or a multi-purpose processor may be adopted. In addition, in a case that a circuit integration technology that replaces LSI appears as the semiconductor technologies advance, an integrated circuit based on that technology may be used.

Although embodiments of the present invention have been described above in detail with reference to the drawings, the specific configurations thereof are not limited to those described above and various design changes or the like can be made without departing from the spirit of the invention.

To describe the present embodiment with reference to FIG. 1, the video coding apparatus 10 includes the image coding apparatus 11 configured to code an input image, the supplemental enhancement information generating apparatus 71 configured to generate supplemental enhancement information indicating whether to perform post-filtering processing on a per picture basis, and the supplemental enhancement information coding apparatus 81 configured to code information indicating whether to continue post-filtering processing in decoding order or display output order in a case of determining whether to continue post-filtering processing on a per picture basis in the supplemental enhancement information. In addition, the supplemental enhancement information coding apparatus 81 codes information for specifying a neural network to be applied to post-filtering processing.

The video decoding apparatus 30 decodes, with the image decoding apparatus 31 configured to decode an image from coded data, the post-filtering processing apparatus 61 configured to perform post-filtering processing on a decoded image that is an image decoded by the image decoding apparatus 31, and the supplemental enhancement information decoding apparatus 91 configured to decode supplemental enhancement information indicating whether to perform post-filtering processing on a per picture basis with the post-filtering processing apparatus 61, information indicating whether to continue post-filtering processing in a decoding order or in a display output order in a case that it is determined whether to continue post-filtering processing on a per picture basis in the supplemental enhancement information. In addition, the supplemental enhancement information decoding apparatus 91 decodes information for specifying a neural network to be applied to the post-filtering processing.

To describe the present embodiment based on FIG. 1, the video decoding apparatus 30 includes the image decoding apparatus 31 configured to decode coded data to generate a decoded image, the post-filtering processing apparatus 61 configured to perform post-filtering processing on the decoded image, and the supplemental enhancement information decoding apparatus 91 configured to decode supplemental enhancement information used by the post-filtering processing apparatus, wherein the supplemental enhancement information decoding apparatus 91 decodes cross correlation matrix information of the decoded image with a certain bit accuracy independent of a pixel bit length of the decoded image and an original image.

The video coding apparatus 10 includes the image coding apparatus 11 configured to code an input image, the supplemental enhancement information generating apparatus 71 configured to generate supplemental enhancement information for post-filtering processing, and the supplemental enhancement information coding apparatus 81 configured to code the supplemental enhancement information, wherein the supplemental enhancement information generating apparatus 71 generates cross correlation matrix information of a local decoded image with a constant bit accuracy independent of a pixel bit length of the decoded image and an original image, and the supplemental enhancement information coding apparatus 81 configured to code the cross correlation matrix information is included.

To describe the present embodiment based on FIG. 1, the video decoding apparatus 30 includes the image decoding apparatus 31 configured to decode coded data to generate a decoded image, the post-filtering processing apparatus 61 configured to perform post-filtering processing on the decoded image, and the supplemental enhancement information decoding apparatus 91 configured to decode supplemental enhancement information used by the post-filtering processing apparatus 61, wherein the supplemental enhancement information decoding apparatus 91 does not decode flag information for an output format at a time when the post-filtering processing apparatus 61 performs up-sampling processing on a chroma pixel of a decoded image in a 4:2:2 format.

The video coding apparatus 10 includes the image coding apparatus 11 configured to code an input image, the supplemental enhancement information generating apparatus 71 configured to generate supplemental enhancement information for post-filtering processing, and the supplemental enhancement information coding apparatus 81 configured to code the supplemental enhancement information, wherein the supplemental enhancement information generating apparatus 71 generates supplemental enhancement information for up-sampling processing of a chroma pixel of a decoded image in a 4:2:2 format, and the supplemental enhancement information coding apparatus 81 does not code flag information for an output format.

An embodiment of the present invention is not limited to the embodiments described above and various changes can be made within the scope indicated by the claims. That is, embodiments obtained by combining technical means appropriately modified within the scope indicated by the claims are also included in the technical scope of the present invention.

### INDUSTRIAL APPLICABILITY

The embodiments of the present invention can be preferably applied to a video decoding apparatus for decoding coded data obtained by coding image data and a video coding apparatus for generating coded data obtained by coding image data. In addition, the embodiments of the present invention can be preferably applied to a data structure of coded data generated by the video coding apparatus and referred to by the video decoding apparatus.

### REFERENCE SIGNS LIST

1 Video transmission system
30 Video decoding apparatus
31 Image decoding apparatus
301 Entropy decoder
302 Parameter decoder
305, 107 Loop filter
306, 109 Reference picture memory
307, 108 Prediction parameter memory
308, 101 Prediction image generation unit
311, 105 Inverse quantization and inverse transform processing unit
312, 106 Addition unit
320 Prediction parameter derivation unit
10 Video coding apparatus
11 Image coding apparatus
102 Subtraction unit
103 Transform and quantization unit
104 Entropy coder
110 Coding parameter determination unit
111 Parameter coder
120 Prediction parameter derivation unit
41 Image display apparatus
51 Pre-filtering processing apparatus
61 Post-filtering processing apparatus
71 Supplemental enhancement information generating apparatus
81 Supplemental enhancement information coding apparatus
91 Supplemental enhancement information decoding apparatus

1-4. (canceled)

5. A video decoding apparatus comprising:
a supplemental enhancement information decoder that decodes a first syntax element and a second syntax element in a neural network post-filter characteristics (NNPFC) SEI message, and
derives a first variable based on a value of the first syntax element and a value of the second syntax element,
wherein
in a case that the value of the first syntax element is equal to one and the value of the second syntax element is equal to one, the first variable is set to an integer value obtained by multiplying a strength control value by a value obtained by left shifting one by a value of a bit depth of chrominance and then subtracting one from the shifted value.

6. The video decoding apparatus according to claim 5, wherein
in the case that the value of the first syntax element is equal to one and the value of the second syntax element is equal to one indicates that two chrominance matrices and one auxiliary input matrix are present in an input tensor.

7. The video decoding apparatus according to claim 6, wherein
the first syntax element indicates whether auxiliary input data is present in the input tensor of a neural network post-filter, and
the second syntax element indicates a method of ordering sample arrays of an input picture.

8. A video coding apparatus comprising:
a supplemental enhancement information coder that codes a first syntax element and a second syntax element in a neural network post-filter characteristics (NNPFC) SEI message, and
derives a first variable based on a value of the first syntax element and a value of the second syntax element,
wherein
in a case that the value of the first syntax element is equal to one and the value of the second syntax element is equal to one, the first variable is set to an integer value obtained by multiplying a strength control value by a value obtained by left shifting one by a value of a bit depth of chrominance and then subtracting one from the shifted value.

9. A non-transitory computer readable medium storing a bitstream generated by encoding video data, the bitstream being decoded by processes of:
decoding, from the bitstream, a first syntax element and a second syntax element in a neural network post-filter characteristics (NNPFC) SEI message, and
deriving a first variable based on a value of the first syntax element and a value of the second syntax element, wherein
in a case that the value of the first syntax element is equal to one and the value of the second syntax element is equal to one, the first variable is set to an integer value obtained by multiplying a strength control value by a value obtained by left shifting one by a value of a bit depth of chrominance and then subtracting one from the shifted value.
